(19) United States
(12) Patent Application Publication
(10) Pub. No.: US 2003/0093244 A1
(43) Pub. Date: May 15, 2003

(54) Network metric system

(76) Inventors: Andrew Corlett, Rancho Santa Margarita, CA (US); Robert Mandeville, Newport Beach, CA (US)

Correspondence Address: BROWN RAYSMAN MILLSTEIN FELDER & STEINER, LLP, SUITE 711, 1880 CENTURY PARK EAST, LOS ANGELES, CA, 90067, US

(21) Appl. No.: 10/080,925

(22) Filed: Feb. 22, 2002

Related U.S. Application Data
(63) Continuation-in-part of application No. 09/864,929, filed on May 24, 2001.

(51) Int. Cl. G06F 15/00; G06F 11/30

(52) U.S. Cl. 702/186

(57) ABSTRACT

A network metric system 10 includes a nodal network 20, a database 40, an application server 46, a workstation 50, and at least one service daemon 60 that interfaces between the nodal network 20 and the database 40. The nodal network 20 is composed of a plurality of nodal members 30 between which one-way measurements are performed over asymmetrical paths. In the network metric system 10, the measurements are performed at the IP layer, in contrast to prior systems that perform measurements at the application layer. Further, the number of nodal members 30 used as measurement points in the nodal network 20 is highly scalable, in order to allow accurate measurements to be performed in network environment of virtually any size. The database 40 stores measurement data that is generated by the nodal members 30. The workstation 50 acts as a user interface to access the database 40 through the application server 46 for system configuration and reporting of the measurement data. The service daemon 60 interfaces with the nodal network 20 and the database 40. The service daemon 60 also instructs the nodal members to create new vectors, obtains vector configuration information from the database, and handles results data transmitted from the nodal members 30 to the database 40. The measurements include packet ordering data for received packets that is defined using a minimal longest ascending subsequence algorithm. The packets that are in the minimal longest ascending subsequence are considered in order, and the packets that are not in the minimal longest ascending subsequence are considered out of order.

### RELATED APPLICATIONS

This application is a continuation in part of U.S. patent application Ser. No. 09/864,929 filed May 24, 2001.

### FIELD OF THE INVENTION

This invention relates generally to network metric systems and, more particularly, to a system and methodology for one-way measurement of network metrics at the Internet Protocol layer to produce comparable measurements for network engineering.

### BACKGROUND OF THE INVENTION

The explosive growth of Internet traffic since the mid-1990s shows no sign of abating and may be expected to continue well into the 21^{st} Century. Accelerating need for bandwidth driven by home and business usage has spawned an Internet-working infrastructure managed by a new industry of Internet service providers (ISPs). As the complexity and connectivity of the multi-layer Internet communication system grows, expanded usage of audio, voice, and video across the Internet seems certain to place unprecedented demand on bandwidth available now and in the foreseeable future. In this context, it is clear that quality of service can only increase in importance as a definitive issue for ISPs and their customer base.

In order to enable control and monitoring capability over Internet services, there is a clear need for precise and scalable metric tools that can give ISPs real-time measurements across nodes and groups of nodes, for a variety of packet types. The availability of a practical and versatile system capable of real-time measurement of one-way loss, delay, jitter, and other parameters defining the quality of service metrics, therefore, would greatly enhance layered network functionality and, at the same time, provide a competitive edge for ISPs who can consistently demonstrate high levels of quality of service performance.

Others have attempted to gather network measurement data and record benchmarks, however, this work has been done almost entirely at the application layer. Measurement data generated at the application layer can then only be compared to measurements performed on the same or similar applications, as well as on the same platform. Further, these measurements can only be compared in roughly the same time period so that the application versions and operating system versions are also of a comparable type. These prior measurement techniques do not produce any basic network layer measurements of the type desired by network engineers that are comparable cross application and cross platform.

Additionally, other past attempts to gather measurement data over proprietary networks and the Internet have utilized a two-way measurement scheme (i.e., a round-trip measurement). This measurement technique has many drawbacks which lead to inaccuracies. For example, in many network systems, such as the Internet, data packets travel in asymmetrical paths. This asymmetrical nature creates obvious difficulties in analyzing two-way measurement data. For these, and other reasons, two-way measurement schemes are very limited in the degree of accuracy that they can provide.

Another problem with prior data measurement gathering systems is that they have been very bandwidth intensive. As these prior measurement techniques use significant bandwidth, the number of measurement points that the system can analyze is limited. Thus, once the system has reached only a few dozen measurement points, the system will break down due to bandwidth limitations. Moreover, customers are not interested in a measurement system that will drastically decrease the efficiency of the network due to the amount of network traffic produced by the measurement technique. These types of bandwidth intensive measurement techniques undesirably prevent the measurement system from being scalable enough to have functional significance in a real-world network environment.

Accordingly, those skilled in the art have recognized the need for a system that is capable of measuring Internet metrics in a scalable network environment to produce accurate and comparable measurements. The present invention clearly addresses these and other needs.

### SUMMARY OF THE INVENTION

Briefly, and in general terms, the present invention resolves the above and other problems by providing a network metric system and methodology which provides comparable measurements over a network at the Internet Protocol (IP) layer for use in network engineering and Internet Service Provider (ISP) performance monitoring. The network metric system of the present invention utilizes nodal members to form a nodal network between which one-way measurements are performed over asymmetrical paths. The measurements are performed at the IP layer, and the number of nodal members in the nodal network is scaleable. The measurements include packet ordering data for received packets that is defined using a minimal longest ascending subsequence algorithm. The packets that are in the minimal longest ascending subsequence are considered in order, and the packets that are not in the minimal longest ascending subsequence are considered out of order. More particularly, the nodal members in the network metric system of the present invention are used as measurement points and have synchronized timing systems. Preferably, in this regard, the nodal members support Network Time Protocol (NTP) timing synchronization and Global Positioning System (GPS) timing synchronization.

In accordance with one aspect of the present invention, the one-way measurements are performed by the nodal members at the IP layer and provide cross-application and cross-platform comparable measurements. The system utilizes a vector based measurement system to achieve service-based, comparable measurements. Preferably, the vector based measurement system defines a vector by an IP source, an IP destination, and a service type. Preferably, the nodal members include multiple on-board processors, enabling one processor to handle management processes and another processor to handle measurement processes.

In accordance with another aspect of the present invention, the nodal members of the network metric system perform processing of the measurement data. Preferably, the nodal members implement a processing algorithm on raw measurement data recorded for each measurement period. This processing algorithm compacts the raw measurement data.

Preferably, the nodal members of the network metric system are autonomous devices that are capable of generating measurement packets, performing one-way measurements at the IP layer, processing measurement data, and temporarily storing measurement data, despite a service daemon or database outage. Preferably, the nodal members are functional without requiring a TCP session with the service daemon.

Another preferred embodiment of the present invention is directed towards a measurement method for performing measurements over a network. The method includes: performing one-way measurements between nodal members over asymmetrical paths, wherein the measurements are performed at the IP layer in a scalable environment; processing data produced by the one-way measurements between nodal members; transmitting the pre-processed measurement data from the nodal members to a database; and analyzing the pre-processed measurement data. The measurements include packet ordering data for received packets that is defined using a minimal longest ascending subsequence algorithm. More particularly, the method of performing one-way measurements between nodal members is achieved by transmitting measurement packets with CQOS headers between nodal members. Preferably, the method of processing the measurement data produced by the one-way measurements between nodal members also compacts the measurement data.

Another preferred embodiment of the present invention is directed towards a measurement system for performing measurements over a network. The system includes a nodal network, a database, an application server, a workstation, and at least one service daemon interfacing with nodal network, and the database. The nodal network includes multiple nodal members between which one-way measurements are performed over asymmetrical paths. In the network metric system of the present invention, the measurements are performed at the IP layer, and the number of nodal members used as measurement points in the nodal network is scaleable. The database stores measurement data processed by the nodal members. The workstation provides a user interface for system configuration, including sending vector configuration information to the database, as well as reporting of the measurement data. The application server interfaces between the database and the workstation for system configuration and results display (obtaining the results data from database and preparing the data for display). The service daemon interfaces with the nodal network and the database. Specifically, the service daemon preferably obtains configuration information from the database, instructs the nodal members to create vectors (configures the nodal members), gathers results data from the nodal members, and stores results data transmitted from the nodal members to the database. The measurements include packet ordering data for received packets that is defined using a minimal longest ascending subsequence algorithm.

In accordance with still another aspect of the present invention; the workstation utilizes a browser based interface to provide system reports and management functions to a user from any computer connected to the Internet without requiring specific hardware or software. Preferably, the user interface of the workstation is alterable without modifying the underlying system architecture. However, the system is capable of performing measurements and storing measurement data without dependence upon the user interface. Preferably, the network metric system implements an access protocol that is selectively configurable to allow third party applications to access the system.

In accordance with another aspect of the present invention, the network metric system implements a CQOS protocol, which is a non-processor intensive, non-bandwidth intensive protocol for transmitting pre-processed, compacted measurement data. In one preferred embodiment of the network metric system, measurement data from each measurement period is sent from the nodal members to the database via this CQOS protocol. The nodal members also communicate with each other and obtain results data using CQOS protocol. Moreover, configuration data and status data are also sent via CQOS protocol.

In accordance with another aspect of the present invention, the database of the network metric system is SQL compliant. In one preferred embodiment of the network metric system, the database stores vector configuration information and results of the measurement data to allow generation of true averages in response to user defined parameters. Preferably, the network metric system provides user-definable groupings of vectors for facilitating vector display and reporting. The nodal members in the nodal network are capable of user-defined customizable groupings for area-specific measurement reporting.

In accordance with yet another aspect of the present invention, the nodal members of the network metric system implement hardware time stamping. Hardware time stamp is more accurate than software time stamping. This system architecture configuration offloads the processor-intensive activity of time stamping and frees up processing power. Each nodal member includes an output buffer, and during the hardware time stamping, header information and data information preferably fill the output buffer before a time stamp is applied to the output buffer.

In accordance with still another aspect of the present invention, the nodal members of the network metric system generate and transmit measurement packets in order to perform one-way measurements at the IP layer. Specifically, the measurement packets have a format that preferably includes an Ethernet header, IP header, optional IP routing options, UDP/TCP header, payload, and CQOS header. In a preferred embodiment of the network metric system, checksums are calculated on the measurement packets for payload, IP header, UDP/TCP header, and CQOS header.

In accordance with yet another aspect of the present invention, the network metric system facilitates user-definable bandwidth allocation for measurement traffic. Preferably, each nodal member automatically calculates the rate at which measurement packets are generated, based upon the number of vectors, packet size, and the bandwidth allocation. In a preferred embodiment of the present invention, the network metric system performs accurate measurements at a high sampling rate.

Still another preferred method of the present invention is directed towards a measurement method that includes: performing one-way measurements between nodal members over asymmetrical paths, wherein the measurements are performed at the IP layer in a scalable environment; processing data in the nodal members produced by the one-way measurements between nodal members; transmitting the pre-processed measurement data from the nodal members to a database via at least one service daemon that interfaces with the nodal network and the database, wherein the at least one service daemon instructs the nodal members to create vectors, obtains vector configuration information from the database, and processes results data transmitted from the nodal members to the database; and providing for system management capabilities and measurement data analysis via the workstation. The measurements include packet ordering data for received packets that is defined using a minimal longest ascending subsequence algorithm.

Yet another preferred embodiment of the present invention is directed towards a measurement system for performing measurements over a network that also performs a readiness test. The system includes a nodal network, a measurement database, a user interface workstation, an application server, and a service daemon. The nodal network includes multiple nodal members between which one-way measurements are performed at the IP layer. The workstation provides a user interface for system configuration, including sending vector configuration information to the database, as well as reporting of measurement data. The application server interfaces between the database and the workstation for system configuration and results display (obtaining the results data from database and preparing the data for display). The service daemon interfaces with the nodal network and the database. In the network metric system of the present invention, a transmitting nodal member performs a readiness test to ensures the willingness of a receiving nodal member to accept measurement traffic before the transmitting nodal member begins to transmit measurement traffic to the receiving nodal member. The measurements include packet ordering data for received packets that is defined using a minimal longest ascending subsequence algorithm.

In accordance with the present invention, the readiness test of the network metric system preferably includes: broadcasting an Address Resolution Protocol request to a gateway/local host in order to obtain its physical hardware address; pinging the gateway/local host; pinging the receiving nodal member; performing a traceroute to the receiving nodal member; and performing a Go/No Go test using a CQOS protocol which is a non-processor intensive, non-bandwidth intensive protocol for nodal members to communicate with each other.

In further accordance with the present invention, the Go/No Go test of the network metric system is performed by a transmitting nodal member requesting and obtaining permission from a receiving device to transmit measurement traffic before the transmitting nodal member transmits the measurement traffic. This ensures protection against unwanted measurements being made on nodal members, as well as against measurement traffic being sent to a non-nodal member receiving device. The readiness test verifies linkage and reachability of nodal members before measurements are performed without burdening the network with unnecessary duplication of effort.

Other features and advantages of the present invention will become apparent from the following detailed description, taken in conjunction with the accompanying drawings, which illustrate by way of example, the features of the present invention.

### BRIEF DESCRIPTION OF THE DRAWINGS

FIG. 1 illustrates a perspective view of the system architecture of the network metric system, in accordance with the present invention;

FIG. 2 illustrates a block diagram of one embodiment of a nodal member used in the network metric system of the present invention;

FIG. 3 illustrates an block diagram of another embodiment of a nodal member used in the network metric system of the present invention;

FIG. 4 illustrates a perspective view of a sample report of the network metric system of the present invention; and

FIG. 5 illustrates a perspective view of an alarm screen of the network metric system of the present invention.

### DETAILED DESCRIPTION OF THE PREFERRED EMBODIMENTS

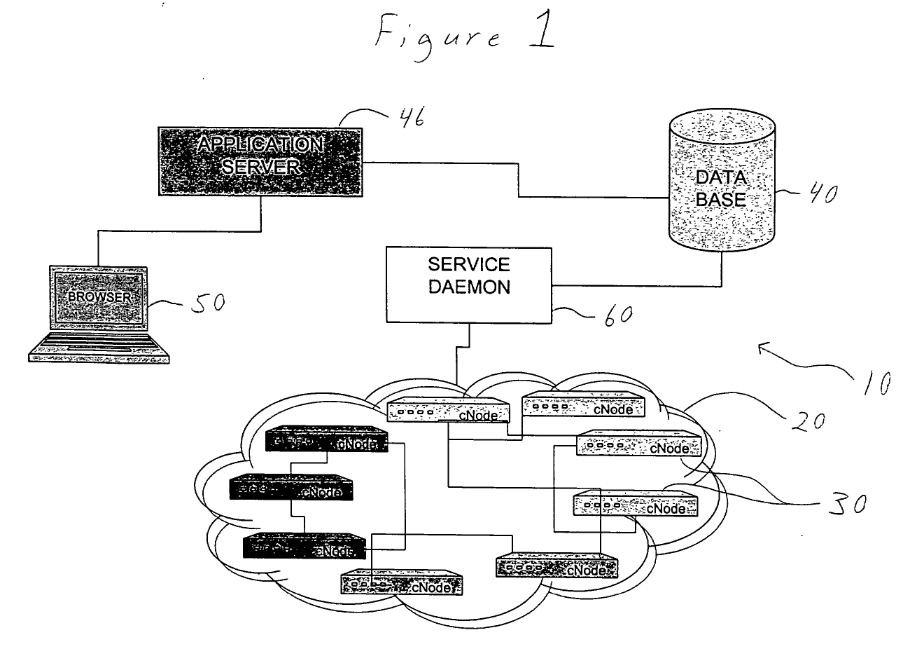

A preferred embodiment network metric system and methodology, constructed in accordance with the present invention, provides comparable measurements over a network at the Internet Protocol (IP) layer for use in network engineering and Internet Service Provider (ISP) performance monitoring. The network metric system is capable of measuring one-way Internet metrics in a scalable network environment to produce accurate, comparable measurements. Referring now to the drawings, wherein like reference numerals denote like or corresponding parts throughout the drawings and, more particularly to FIGS. 1-5, there is shown one embodiment of a network metric system 10 constructed in accordance with the present invention.

Referring now to FIG. 1, the network metric system 10 includes a nodal network 20, a database 40, an application server 46, a workstation 50, and at least one service daemon 60 that interfaces between the workstation 50, the nodal network 20, and the database 40. The nodal network 20 is composed of a plurality of nodal members 30 between which one-way measurements are performed over asymmetrical paths. In the network metric system 10 of the present invention, the measurements are performed at the IP, layer, in contrast to prior systems that performed measurements at the application layer. Further, the number of nodal members 30 used as measurement points in the nodal network 20 is highly scalable, in order to allow accurate measurements to be performed in network environments of virtually any size. The database 40 stores measurement data that is generated by the nodal members 30. The workstation 50 is connected to the database 40 via the application server 46, and provides a user interface for system configuration, including sending vector configuration information to the database. The workstation 50 also provides a user interface for reporting of the measurement data. The application server 46 interfaces between the database 40 and the workstation 50 for system configuration and results display. Results display includes obtaining the results data from database 40 and preparing the data for display. One or more service daemons 60 interface between the nodal network 20 the database 40.

In a preferred embodiment of the network metric system 10, measurements are accomplished by transmitting CQOS measurement packets from one nodal member 30 to another nodal member 30. This measurement is made of a one way trip, which is a major improvement over traditional methods (using ping or similar techniques) that measure round trip times. In general, these measurements are made with nanosecond resolution when a Global Positioning System (GPS) time synchronization system is utilized. These measurements are made with up to 1 millisecond resolution when using a network time protocol (NTP) synchronization system. In one preferred embodiment of the present invention, results are calculated based upon a 5 minute measurement period and are transmitted from the receiving nodal member 30 to the database 40 for later analysis.

In a preferred embodiment of the present invention, a vector is used to describe a measurement case. Each vector has a start point and an end point. The start point is the nodal member 30 that is transmitting CQOS measurement packets to the receiving nodal member 30, the later of which is the end point. Hereinafter, the terms transmitter and receiver are considered equivalent to start point and end point nodal members, respectively.

In a preferred embodiment of the network metric system 10 of the present invention, a vector is the fundamental definition of the path and measurement traffic between two nodal members 30 for the calculation of measurements at the IP layer. As the fundamental measurement service element, a vector describes the path and measurement traffic type between two nodal members 30. It is uniquely defined by a measurement packet between specific IP source and destination addresses. In this embodiment, a vector is defined by an IP source, an IP destination address, and a service type (differentiated service bits), with user-definable TCP/UDP ports, payload (zeros, ones, or random), and packet size. This fundamental IP layer metric allows for service-based, comparable measurements that translate cross-application and cross-platform. With this flexibility, customers can configure vectors to create high-fidelity measurements that exactly match their existing and/or planned IP traffic.

Each vector has an associated set of characteristics. These characteristics include items such as packet size, payload type, header type (none/UDP/TCP), udp/tcp source and destination port numbers, TOS/DiffSev bits, TTL value, IP protocol value, IP options, default gateway, source and destination addresses, and TCP header information. Further, a certain set of characteristics can be assigned a name such as ‘high priority’ or ‘best effort’. This makes it easy to reuse a particular set of characteristics.

In a preferred embodiment of the network metric system 10, all measurements are made on the end point nodal member 30. The nodal member 30 is called the vector handler. It is the responsibility of the transmitter to send out measurement packets to the receiver. It is also the responsibility of the transmitter to send out an ending packet at the end of each measurement period. This ending packet signals the receiver that all packets in the measurement period have been transmitted. Once the receiver acquires the ending packet at the end of the measurement period, the receiver becomes responsible for gathering the data of all packets received from the transmitter, calculating the results based on the data contained in the packets, and finally sending the results to the database 40 for storage.

In a preferred embodiment of the network metric system 10 of the present invention, the CQOS service daemon 60 is the foundation of the scalable and reliable application server architecture. In a preferred embodiment, the service daemon 60 interfaces with the nodal members 30 and the database 40, instructs the nodal members to create new vectors, obtains vector configuration information from the database 40, and handles results data transmitted from the nodal members 30 to the database 40. Initially, vector configuration information is sent from the workstation 50 through the application server 46 to the database 40. In some embodiments to the present invention, multiple service daemons 60 are run simultaneously to provide for system redundancy. In the embodiments of the present invention that utilize multiple service daemons 60, the system 10 employs a Solaris based operating system, instead of Windows NT. If a service daemon 60 experiences a failure, the nodal members 30 continue to measure and store their results until a replacement daemon is activated.

In a preferred embodiment of the present invention, the service daemon 60 allows the network metric system 10 to be self-sustaining, with measurements performed, and results stored, without dependence upon the user interface. Further, the service daemon 60 allows the user interface to be changed or otherwise updated without affecting the underlying system architecture. Moreover, the service daemon 60 preferably allows the flexibility to potentially let third-party applications access the measurement system 10, as desired.

In a preferred embodiment of the network metric system 10 of the present invention, the one-way measurements are performed by the nodal numbers 30 and provide cross-application and cross-platform comparable measurements. As described above, the system utilizes a vector-based measurement system 10 to achieve service-based, comparable measurements between the nodal numbers 30. Specifically, the vector-based measurement system 10 defines a vector using an IP source, an IP destination, and a service type.

A nodal member 30 can be configured to be the start point or end point of many vectors simultaneously. Note that the packet sent out at the end of each measurement period is not sent for each vector, but rather it is sent on a per nodal member 30 basis. For example, if one nodal member 30 is the transmitter of two vectors to the same receiving nodal member, the transmitting nodal member only sends one packet at the end of the measurement period, hot two.

The nodal members 30 in the network metric system 10 of the present invention perform measurements and store measurement data over a set measurement period. As described above, the results are preferably calculated based on a 5 minute measurement period. However, any desired measurement period may be used in other embodiments of the present invention. The results data for each measurement period is sent from each nodal member 30 to the database 40 utilizing the CQOS protocol for later analysis. The CQOS Protocol is a communications protocol that is used for communication between nodal members 30 and the other elements of the network metric system 10. The results for each measurement period are sent from each nodal member 30 to the service daemon(s) 60 and then onwards to the database 40 utilizing the CQOS protocol. Moreover, configuration data and status data are also sent via CQOS protocol.

The CQOS protocol is an efficient, secure, non-processor intensive, non-bandwidth intensive transfer protocol. Use of the CQOS protocol allows processor and bandwidth intensive protocols such as Simple Network Management Protocol (SNMP) to be avoided. The CQOS protocol is also used for communication between nodal members 30. Moreover, the CQOS protocol can be expanded and modified, as needed, throughout the development life cycle of the product.

Set of Metrics

The network metric system 10 of the present invention measures and reports a complete set of Internet metrics that are useful to network engineers for proper network design and configuration. The completeness of these Internet metrics provides significant advantages over prior measurement gathering systems. Specifically, the Internet metrics, in accordance with the present invention, preferably include, by way of example only, and not by way of limitation, code version number, source identities, time parameters, sequence/byte/packet loss, out-of-order packets, error packets' types, sequential packet loss (loss patterns), packet hop count, IP protocol tracking, packet TOS and DiffServ changes, packet jitter, one-way latency, outages, and route information. Furthermore, many of these Internet metrics can be subdivided and described in further detail.

The code version number provides the version number of software operating in the nodal members 30, which is important when updates are made or are being planned. In source identities, the sending nodal member ID should be recorded as well as the sending vector ID. Regarding the sending nodal member ID, all nodal members 30 have a hard-coded identity and can be named. With respect to the sending vector ID, a default identifier of all vectors is automatically created.

In the time parameter category, specific metrics include measurement period ID, nodal measurement period ID, and universal time. The measurement period ID is defined as continuous time divided into periods identified by measurement ID. The nodal member measurement period ID relates to the measurement period of the nodal member that is transmitting packets. The universal time metric provides an absolute time reference for all measurements.

Several Internet metrics relate to sequence, byte, and packet loss. These include sequences received, bytes received, bytes transmitted, packets received, and packets transmitted. Referring to the sequences received metric, when packets are sent to multiple nodal members 30, each nodal member receives a sequence of packets in turn. The number of sequences received is counted separately from the number of bytes and packets received. In order to measure sequential packet loss (the number of packets dropped in a row), it is necessary to be able to identify the sequence in which the packet was sent. This should be indicated per measurement period. Packet loss is calculated as the number of packets transmitted minus the number of packets received. Packet loss does not take account of duplicate packets. The bytes received metric refers to the number of bytes received per measurement period. Bytes transmitted is defined as the number of bytes transmitted per each measurement period. Packets received is defined as the number of packets received per measurement period. Finally, packets transmitted is defined as the number of packets transmitted per measurement period. The out-of-order packets metrics category includes a measurement for packets out of order and groups out of order. Referring to the packets out of order measurement, nodal members 30 implement the sophisticated algorithm described below (in the Minimal Longest Ascending Subsequence section) to calculate the number of packets that arrive out of order. Since such packets may be grouped together, the system also applies the algorithm to groups of out-of-order packets to produce the group's out-of-order measurement.

Error packet types are a large category of Internet metrics. These include packets duplicated, minimum packets duplicated, maximum packets duplicated, packets dropped, packets dropped due to missing fragment, packets fragmented, minimum packets fragmented, maximum packets fragmented, average packets fragmented, IP packets corrupted, CQOS info packets corrupted, pay load packets corrupted, and optional header packets corrupted. The packets duplicated metric is produced by identifying duplicated packets and accounting for duplicated packets in the calculation of packet loss. The packets dropped metric identifies the packets transmitted and the number of which were dropped. This calculation takes account of duplicated packets. The packets dropped due to the missing fragment metric accounts for packets that were received but counted as drop packets due to missing fragments. The packets fragmented metric is defined as the number of packets received that were fragmented. In the IP packets corrupted metric, the nodal members 30 identify corruption in the IP header. In the CQOS information packets corrupted metric, the nodal member 30 identifies corruption in the CQOS information field. In the payload packets corrupted metric, the nodal member 30 identifies corruption in the payload. Finally, in the optional header packet corrupted metric, the nodal member 30 identifies corruption in the optional header.

The sequential packet loss (loss patterns) category also preferably includes numerous sub-categories of desirable metrics. These include minimum sequential packets dropped, maximum sequential packets dropped, average sequential packets dropped, standard deviation of sequential packets dropped, minimum sequential packets lost, maximum sequential packets lost, average sequential packets lost, and standard deviation of sequential packets lost. All of these sequential packet loss pattern metrics are calculated using the number of packets dropped in immediate succession to each other. These calculations are performed for both lost and duplicated packets.

The packet hop count category of metrics preferably includes the sub-categories of packets TTL changes, packets TTL minimum, packets TTL maximum, and packets TTL average. For each of these packets TTL-based metrics, the measurements are calculated by using the hop count derived from the changes in the time-to-live field in the IP header of the packet. TTL (time to live) is a function that limits the life of a packet to a designated number of hops between nodal members 30. The time-to-live function is useful in identifying the length of a path taken by a packet between two nodal members 30, and is particularly useful with respect to packets that move along asymmetrical paths.

In the network metric system 10 of the present invention, the Internet metrics being recorded also include packet IP protocol errors and packet IP protocol changes within the category of IP protocol tracking. Further Internet metrics being tracked include the category of packet type of service (TOS) and differentiated services (DiffServ) changes. Subcategories of metrics within the packet TOS and DiffServ changes category include the packets TOS changes metric, in which the nodal members 30 record differences in the TOS field, as well as the packets first ten TOS count metric.

Still another Internet metrics category is packet jitter. Further metrics within this category include jitter minimum, jitter maximum, jitter average, jitter standard deviation, and jitter standard deviation power 4. The jitter standard deviation power 4 metric allows calculation of statistical accuracy from which minimum, maximum, and standard deviation for jitter are reported.

One-way latency is another general category of metrics under which several specific Internet metrics are preferably tracked. These include latency minimum, latency maximum, latency average, latency standard deviation, latency standard deviation power, and latency time stamp mismatch. The latency standard deviation power metric is used to allow calculation of statistical accuracy, from which the minimum, maximum, and standard deviation for jitter are reported.

Another Internet metric's category of outages in the network metric system 10 of the present invention includes the subcategories of outages, outage duration, minimum outages, outage duration maximum outages, and outage duration total outages. These subcategories of outage metrics are calculated by using a certain period measured in nanoseconds after which an outage counter is started if no packets are received. The outage counter is stopped when the first new packet is received.

The final category of Internet metrics that is tracked by a preferred embodiment of the network metric system 10 is that of route information. The system records first and last packet information for all packets of a measurement period that have IP options set for record route, strict route, or loose routes. The record route function records the actual path taken by a packet between two nodal members 30. The strict route function forces a packet to take a specific path of travel between two nodal members 30. The loose route function allows the packet to take any path as it is routed between nodal members 30. The specific sub-categories of Internet metrics recorded within the route information category include first route type, first route count, first route packet ID, first route data, last route type, last route count, last route packet ID, and last route data.

VectorHandler

The VectorHandler class is used to encapsulate all received packets and result calculations for a single measurement period. It inherits from the AtomicAlgorithms that contains all of the result calculation routines except for one, the CalculateResults routine.

CalculateResults Method

This method is called two minutes after the measurement period is over and the ending packet, indicating that all packets have been sent, arrives from the transmitter. This method retrieves the packets for a given measurement period. It then retrieves the non-unique 0 based period ID from the first packet with a non-corrupted CQOS header. After allocating the required memory to calculate the results, it calls additional methods to do most of the calculations (specifically the methods listed in the AtomicAlgorithms section). This method then gathers the version information, temperature information, vector identification information, additional vector information, route information, and port counters and places them in the results structure. Finally, it calls a method to place the results into the hash tables for temporary storage before transmitting them out to the database on another computer.

Inputs: nodal memberMPeriodID—unique period ID on which the measurement period calculates results.

Outputs: None

Returns: TRUE if results were calculated, FALSE if results could not be calculated.

AtomicAlgorithms

This class contains all of the methods that are used by VectorHandler, which inherits this class, to calculate results from the AtomicPacketData linked lists for a measurement period.

mc ProcessFirstPass Method

This method loops through all of the AtomicPacketData packets and places all packets with non-corrupted CQOS headers in the rInfo array. During this process, the method saves any information in the results struct that can be obtained from the packets even if certain headers are corrupted or duplicates occur. The main results it calculates are bytes received, packets received, fragmentation, TTL, IP protocol, TOS, latency, and header error results.

Inputs: results—pointer to results struct

atomic—pointer to head of AtomicPacketData linked list with all packets

rInfo—point to preallocated array to hold all packets with non-corrupted CQOS headers

rCount—maximum number of items rInfo array can hold

Outputs: results—saves appropriate results calculated in this method

rInfo—array with all packets with non-corrupted CQOS headers

Returns: all 0×F's if error, number of valid items in rInfo array if no errors

mc ProcessSecondPass Method

This method allocates memory for duplicated packets and sorting arrays. It then loops through all of the packets placed by mc_ProcessFirstPass into the rInfo array and places all duplicates found into the duplicated packets array. Next, the method sorts the items in the rInfo array which are not duplicates into transmission order. Based on the sorted order it calculates jitter by looping through the packets in order transmitted. Outage results are then computed by looping through the packets in the order received and comparing the times received with the min outage value ignoring duplicates. Duplicate results are then calculated by looping through the items previously placed in the duplicate list. Finally, all values previously calculated are placed in the results structure.

Inputs: results—pointer to results struct

rInfo—array with all packets with non-corrupted CQOS headers

rCount—count of all packets received

txPackets—count of packets transmitted

rxPackets—count of all packets received

outageTriggerTimeNS—minimum time considered for an outage in nsec

mPeriodNanoseconds—UTC time of period in nsec

nodal memberVerifyRxTimestamp—time end of period message was received

outageCoolCount—number of items to check to be able to verify an outage without using end of period time

Outputs: results—saves appropriate results calculated in this method

rInfo—array with all packets with non-corrupted CQOS headers with duplicate information added by this method

Returns: all 0×F's if error, number of duplicated items if successful

mc ProcessThirdPass Method

This method loops through an array of rInfo items to find the number of items, and groups of items that are out of order. It places those results in the rxGroupsOutOfOrder and rxPacketsOutOfOrder result fields.

Inputs: results—pointer to results struct

rInfo—point to preallocated array to hold all packets with non-corrupted CQOS headers

rCount—number of packets received

Outputs: results—saves appropriate results calculated in this method

Returns: FALSE if an error occurs, TRUE if successful

mc IsDuplicatedAbove Method

This method used by mc_ProcessSecondPass to loop through duplicates that are before the current item. If a duplicate is found before the item then TRUE is returned. Otherwise FALSE is returned.

Inputs: r—pointer to current item

currentPosition—index of current item in r array

duplicatedList—array of indexes of duplicated items

duplicatedListCount—number of items in duplicated list

rInfo—array of PACKETRecordInfo items

rCount—number of items in rInfo array

Outputs: None

Returns: TRUE if duplicated above, FALSE if not

mc FindTransmittedPacket Method

This method is used by mc_ProcessSecondPass to loop through an array of rInfo items to try and find a packet with the correct sequence number.

Inputs: sequence—number of sequence to look for

rInfo—array of PACKETRecordInfo items

rCount—number of items in rInfo array

startIndex—index of where item should be

Outputs: None

Returns: all 0×F's indicates not found, index number of packet

mc StripBeg Method

This method is used by mc_ProcessThirdPass to find groups at the beginning of the array and return the new first index of the array. It also updates the current minimum value.

Inputs: rInfo—point to preallocated array to hold all packets with non-corrupted CQOS headers

FirstPosition—index to start from

LastPosition—max index to stop at

Marked—array of indexes already marked

CurrentMin—the current minimum value

Outputs: CurrentMin—the new min (could stay the same)

Returns: The new first position

mc StripEnd Method

This method is used by mc_ProcessThirdPass to find groups at the end of the array and return the new last index of the array. It also updates the current maximum value.

Inputs: rInfo—point to pre-allocated array to hold all packets with non-corrupted CQOS headers

FirstPosition—index to start from

LastPosition—max index to stop at

Marked—array of indexes already marked

CurrentMax—the current maximum value

Outputs: CurrentMax—the new max (could stay the same)

Returns: The new last position

Packet Format

The measurement packets, in accordance with a preferred embodiment to the present invention, utilize a specific, efficient packet format. This packet format includes all of the pertinent information required for the methodology of the network metric system 10 of the present invention. In one embodiment of the present invention, the packet format is configured as: Ethernet header, IP header, optional IP options (strict, loose, or record route), TCP/UDP header, payload, and CQOS data. Preferably, check sums are calculated for payload, IP header, TCP/UDP header, and CQOS header.

CQOS Measurement Packet Structure

Shown below is one format of a CQOS measurement packet. It consists of an Ethernet Header and checksum, an IP header, the payload, and a CQOS header. These items are briefly described in the sections that follow except for TCP/UDP headers. TCP/UDP headers are not discussed because measurement of TCP/UDP packets to application ports is not measured.

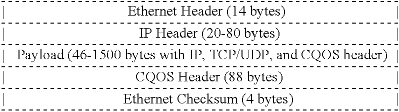

Ethernet Protocol and Header Information

The Ethernet protocol is the protocol actually used to physically transport packets to and from the nodal members 30, and to and from the router connected to the nodal members. The format of an Ethernet packet is shown below.

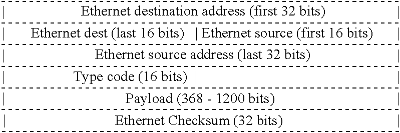

The Ethernet destination address is a 48 bit unique identifier of the Ethernet controller to receive the packet. The Ethernet source address is a 48 bit unique identifier of the Ethernet controller transmitting the packet. The payload is the portion where TCP/UDP, IP and CQOS header information resides. It also is the portion where any other data sent is contained. The maximum size of the payload section is 12000 bits which defines the maximum size of data that can be sent per packet. The Ethernet checksum is a 32-bit value that is used to validate the contents of the entire Ethernet packet.

IP Protocol and Header Information

The IP protocol is used to transport packets across the Internet regardless of the actual connection protocols between routers. This protocol lies at the heart of the Internet and its header fields contain information that is saved in the results.

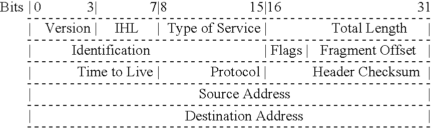

The version field contains the current version of IP (normally 4). The IHL field contains the length of the header in 32 bit words. This is normally 5 except when an IP optional header is used in which case it can be up to 15. (Verify IP optional header size.). The Type of Service (TOS) field contains priority information that may or may not be used by routers to give packets higher or lower priority. The Total Length field specifies the total length of the packet (excluding the Ethernet header and checksum) in bytes. The Identification field is used to identify the packet.

The Flags field (3 bits) is used in fragmentation. The first bit, if set, signifies that routers should not fragment the packet. If a router must fragment a packet and the first bit is set, the router will drop the packet. The last bit, if set, signifies that there are more packets after this packet that were originally part of one packet but were fragmented into smaller ones. The Fragment Offset (13 bits) is the offset from the previous beginning of the original packet if it is fragmented into smaller pieces. It is in units of 8 bytes. The Time to Live (TTL) field indicates the max number of hops that this packet can take before reaching the receiver or the packet is dropped. The Protocol field indicates the transport protocol used (ICMP=1, IGMP=2, TCP=6, UDP=17).

The Header Checksum is used to validate the contents of the IP header. To calculate the checksum, all fields in the IP header (except for this field that is ignored) are treated as 16-bit numbers and complemented. Then all are summed and stored here. Upon receiving the packet all are summed and if all 1's then the header is not considered corrupt. The Source Address contains the IP address of the transmitting host. The Destination Address contains the IP address of the receiving host.

COOS Protocol and Header Information

The CQOS header is contained at the end of the Ethernet payload. This header contains original values of data that can be changed during transmission of a packet. It is located by subtracting the size of the CQOS header (88 bytes) from the end of the payload section. If the packet is corrupted, CQOS header can also be found because the first field is 64-bit ASCII field that contains CQOS.

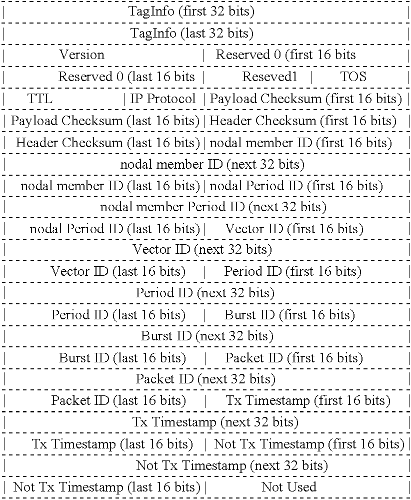

The TagInfo field contains the identifier of the beginning of the CQOS which consists of the ASCII CQOS value and is used to find the header if the parts of the packet are corrupted. The Version field contains the version of the protocol −1. The TOS field contains the original TOS set on the transmitting nodal member 30. The TTL field contains the original TTL set on the transmitting nodal member 30. The IP protocol field contains the original IP protocol set on the transmitting nodal member 30. The P Checksum (Payload Checksum) field contains a checksum for the entire payload. The H Checksum (Header Checksum) field contains a checksum for the CQOS header.

The nodal member ID field contains the unique ID of the transmitting nodal member 30. The nodal member Period ID field contains the unique ID of the period for the nodal member 30. The Vector ID contains the ID of the vector. The Period ID contains the 0 based ID of the measurement period. The Burst ID contains the identifier of the burst that this packet is in. The Packet ID contains the identifier of this packet (sequence number). The Tx Timestamp contains the timestamp of the packet when it was transmitted. The Not TX Timestamp field contains the inverse of the Tx Timestamp field so that the field can be verified even if other parts of the header is corrupted.

Nodal Member Hardware

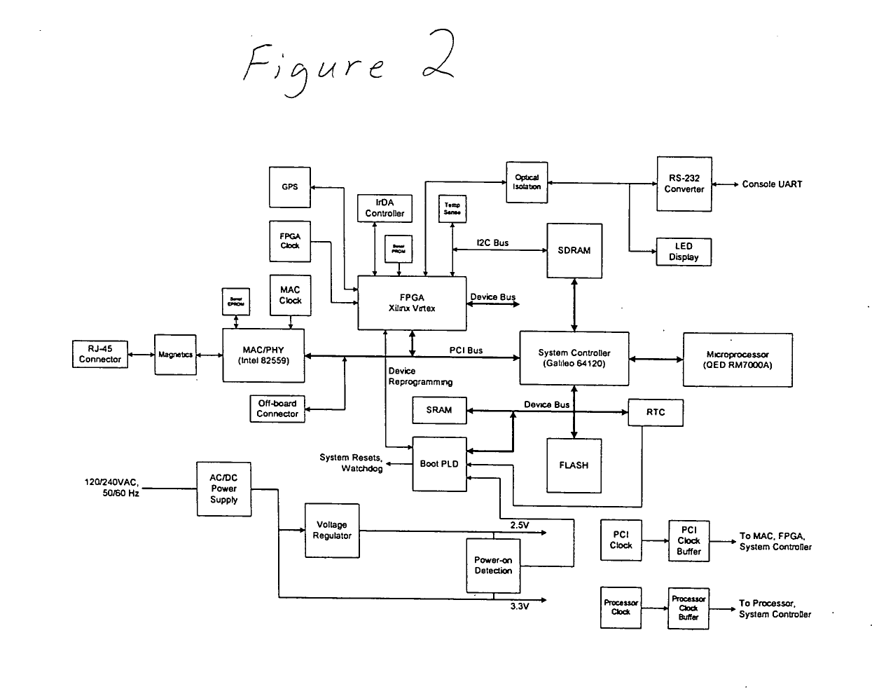

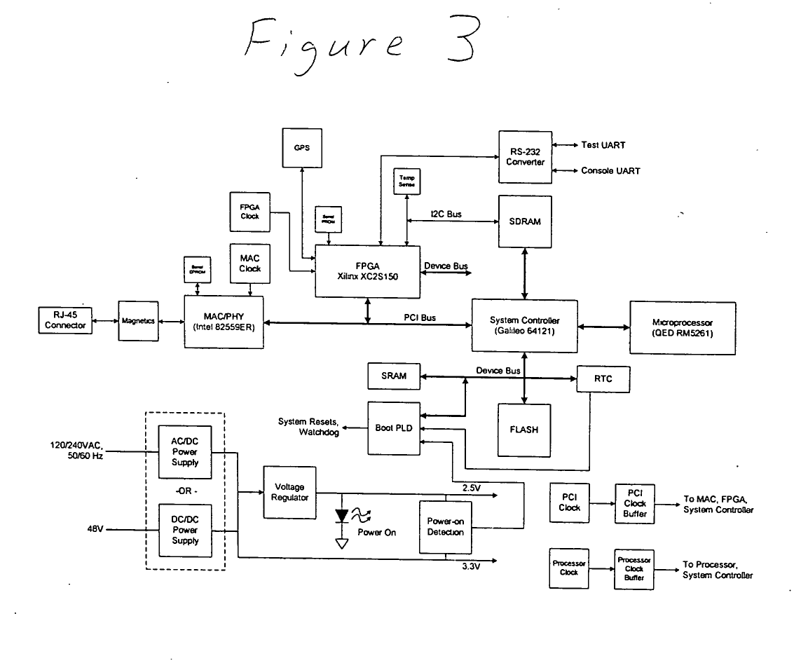

Referring now to FIGS. 2 and 3, in one preferred embodiment to the present invention, the nodal members 30 contain on-board intelligence, multiple on-board processors, 64-bit counters, full Internet-working functionality, Ethernet ports, a rack-mountable configuration, dual modes of type synchronization, and intelligent upgrading. In one embodiment, each nodal member 30 has two 10/100 MBPS Ethernet ports. Preferably, one port is used for measurement traffic and in-band management traffic. The second port may optionally be used for out-of-band management. This configuration provides the benefit of allowing management traffic to be run on a separate management network.

In the network metric system 10 of the present invention, the nodal members 30 are designed with feature expansion in mind, and with room for additional measurement network interfaces. In a preferred embodiment of the present invention, the nodal members 30 are rack-mountable devices that include two U-boxes with front panel LEDs, an IrDA port, and a serial port. Preferably, a command line interface is also accessible through either the serial port, IrDA port, or Telnet. This rack-mountable configuration provides desirable space efficiency. Further, the IrDA port eliminates the requirement for a serial cable for basic configuration and diagnostics. This also allows CE devices and palm pilot devices to be used for configuration.

There are two main components that comprise the nodal members 30, Component 1 (a.k.a. Big Joe), and Component 2 (a.k.a. Mercury). Each component is responsible for different tasks and has different connected interfaces. Component 1 contains the time stamping hardware, an Ethernet controller, and a microprocessor. It connects to the auxiliary serial port at the back of the box, the GPS connector, the PPS signal, the Ethernet Measurement port, and Component 2. Component 1's main responsibility is to transmit and receive packets. When transmitting or receiving packets, Component 1 places a very accurate time stamp in the packet (as described below). Packets received are sent to Component 2 for further processing.

Component 2 contains an Ethernet controller and a microprocessor. It connects to the serial port at the front of the box, the PPS signal, the IRDA interface, the Ethernet Auxiliary port, and Component 1. Component 2's responsibility is to keep track and store vectors and their respective packets, calculate results at the end of measurement periods, and handle any high level protocols. The results previously mentioned are calculated on Component 2, except for the layer 2 calculations. All the classes and methods described below are contained in Component 2.

Time Stamping

In one preferred embodiment of the present invention, the nodal members implement hardware time stamping. Hardware time stamp is more accurate than software time stamping. Additionally, the hardware time stamping offloads the processor-intensive activity of time stamping to free up processing power. Preferably, the time stamp is applied to the output buffer after the header information and data information fill the output buffer, so as to more closely represent the time at which the measurement packet is actually transmitted. Using this technique, the time stamp is generated very close to the actual transmit time, such that any remaining delay between the time request and the application of the time stamp, or the transmission of the packet, is discernable with substantial accuracy to permit advancing the time stamp to actual transmission time. As a result, the latency time, as measured by receiving input to the receive nodal member 30, is substantially devoid of inaccuracy due to processing times and processing variations in the transmitting nodal member 30.

Because the time stamp is generated a short period before it is applied to the packet and the packet is output, the delay between generation of the time stamp and application or packet output, is predictable with substantial accuracy. Unlike conventional systems, the time stamp is not generated before the output buffer begins to fill, and therefore, is not subject to processing delays and irregularities that precede filling the output buffer. Consequently, the time stamp generated can be advanced by a predictable time increment such that the time stamp actually correlates to the time at which the time stamp is applied to the packet, or when the packet is output to the ISP transmission path. This allows application of a time stamp that is initiated at the time at which the packet is formed, or transmitted, not an earlier time.

In a preferred embodiment of the network metric system 10, the receiving nodal member 30 similarly generates a time stamp as the packet fills the input buffer, rather than after the packet is further processed. As such, the receive time stamp is offsetable by a predictable time delay to correlate to the time at which the packet is actually received at the receiving nodal member 30. One-way signal latency may, therefore, be accurately determined with a minimum of corruption due to variable internal processing within the sending and receiving nodal members 30.

Node Processing

In a preferred embodiment of the network metric system 10 of the present invention, each nodal member 30 includes sufficient onboard intelligence to perform processing of the measurement data for each measurement period. This is achieved by implementing a complex algorithm (described in detail below) and compacting the results, preferably to one kilobyte per five minute measurement period per vector. This distribution of intelligence to each nodal member 30 allows the system to eliminate centralized processing of the raw data. Further, this onboard intelligence and processing ability of the nodal members 30 minimizes the results traffic on the network, thus, increasing scalability as a result of this distributed processing. Moreover, this system architecture eliminates the problem of single-point failure. Each nodal member 30 stores up to 48 hours of vector information in a circular buffer. If the receiving nodal member 30 does not receive a packet signaling the end of a vectors measurement period within that period, the vector information for that period is considered invalid and is discarded.

A preferred embodiment nodal member 30 of the network metric system utilized multiple on-board processors. This allows one processor to handle management processes, while another processor handles measurement processes. This configuration also has the benefit of increasing scalability of the system. Further, the nodal members 30 in one preferred embodiment of the present invention utilize counters with exclusively 64-bit values. This allows wrapping of the counters to be avoided.

In a preferred embodiment network metric system 10, the nodal members 30 are true Internet working devices, which are capable of supporting TCP/IP, SNMP, Telnet, TFTP, dhcp, BootP, RARP, DNS Resolver, Trace Route, and PING. The nodal members 30 are high-quality devices that service providers can confidently deploy and manage within their own systems.

The nodal members 30 in the network metric system 10 of the present invention have synchronized timing systems. In this regard, the nodal members 30 preferably support network time protocol (NTP), Version 3. A preferred embodiment of the present invention supports synchronization to multiple NTP servers. This synchronization is used in the calculation of one-way latency and jitter measurements. The one-way latency measurements provide insight into the asymmetric behavior of networks, and adds a dimension of understanding of the performance of real-time applications (voice and multimedia). A preferred embodiment of the present invention also supports global positioning system (GPS) time synchronization, however, the system 10 avoids dependence solely on GPS which can sometimes be difficult to support.

Advantageously, nodal members 30 of the present invention are preferably capable of intelligent upgrading. In this regard, the upgrading of the nodal members 30 is automated, and as such, facilitates extreme scalability up to very large numbers of deployed nodal members 30, while maintaining minimal loss of measurement time. This ability greatly enhances ease of upgrading large deployments. Moreover, after download, new images are booted on all nodal members 30 in a synchronized fashion.

In a preferred embodiment of the network metric system 10 constructed in accordance with the present invention, the system implements several redundant features in order to account for any occasional failures or errors in the system. The nodal members 30 are equipped with a substantial amount of memory storage capacity (typically as RAM) and store results data for a period of time after the results have been sent to the database 40. If a results packet is lost in the transmission, the service daemon 60 senses this loss and implements the necessary procedures to retrieve the results. This type of automated error recovery allows for the network metric system 10 of the present invention to act as a carrier class, long-term, unattended system deployment.

In one preferred embodiment of the network metric system 10, each nodal member 30 employs dual power supplies in order to provide for a backup power source in the case of a power supply failure. Moreover, in accordance with the autonomous nature of the nodal numbers, if a transmitting nodal member 30 is restarted for any reason, the nodal member 30 automatically goes through a Readiness Test and a Go/No-Go Test (described below), followed by the automatic resumption of measurements without any required user intervention. Correspondingly, if a receiving nodal member 30 is restarted and loses its vector handlers, then the nodal member 30 automatically sends a message back to the transmitting nodal member 30 indicating that the receiving nodal member 30 does not have a vector handler for the packets that the transmitting nodal member 30 is sending. The transmitting nodal member 30 then goes through its tests, and normal operation is resumed. Advantageously, during such temporary outages as described above, the time periods for which there is no data are correctly accounted for as downtime for a nodal member 30, and not lost measurement packets.

Readiness Test

As described above, in a preferred embodiment of the present invention, each transmitting nodal member 30 insures the readiness of a receiving nodal member 30 before the transmitting nodal member 30 begins to send measurement traffic to another receiving nodal member 30 by performing a Readiness Test. This Readiness Test verifies linkage and reachability between nodal members 30 before a test is run, without overburdening the network with unnecessary duplication of effort. Specifically, in a preferred embodiment network metric system 10, a transmitting nodal member 30 performs a five-step Readiness Test upon creation of a new vector by the service daemon 60, or after a restart or other anomaly. These steps include: (1) broadcasting and address resolution protocol request to a gateway/local host in order to obtain its physical address; (2) pinging the gateway/local host; (3) pinging the destination nodal member 30; (4) performing a trace route to the destination nodal member 30; and (5) performing a Go/No-Go Test using the CQOS protocol.

In a preferred embodiment of the present invention, the Go/No-Go Test provides protection from unwanted or unauthorized measurements being made on nodal members 30 within the system, as well as providing protection from having nodal member 30 measurement traffic accidentally sent to a non-nodal member device. Additionally, the network metric system 10 preferably also employs password protection in order to limit access as desired (e.g., access to management applications).

Type of Service

A preferred embodiment to the present invention also provides users with the ability to define multiple service types prepare of nodal members 30. For example, a user is able to specify TCP/UDP Port, DiffServ (differentiated services) field bit values, payload (zeros, ones, and random), and packet length for each user-defined service type. This type of quality of service specific behavioral information is then readily available in the system reports. Further, the work stations and preferred embodiments of the present invention also allow vectors to be disabled without being deleted from the database 40. This provides the advantage of saving a user from having to redefine a previously defined vector.

Certain networks support different priority levels for the routing of network traffic. These policies can be based on the type of service (TOS) field settings in a packet or they can also be based on other parameters such as the source address, packet contents, port number, or other header information. TOS field or differential services settings indicate data delivery priority. This priority may or may not be ignored by the routers in the path to the receiving nodal member 30. Some routers may actually replace these settings with different ones.

For example, a router supports two policies, ‘high priority’ and ‘best effort’, with the default being best effort. The router knows by a packet's TOS field settings if the packet is a default best effort packet or a high priority packet. The router then schedules the packets transmitted based on the policy. For example, the router reserves 25% of the sending bandwidth for high priority packets and the rest of the transmitting bandwidth for best effort packets. Because TOS fields and other parameters that affect QOS can be modified it is possible to measure the different QOS policies and their effects.

Measurement Sequence

In a typical system packets are sent one at a time in a round robin fashion. In order to measure jitter, a minimum of 2 packets from a single vector must be transmitted in order with no other packets in between. The number of packets that are transmitted one after another in a vector is called the measurement sequence. This is also known as a burst. A measurement sequence size of one is equivalent to the normal round robin transmission scheme. This can be used if the jitter calculations are not desired.

This embodiment of the present invention utilizes a round-robin measurement sequence. When multiple vectors are defined per nodal member 30, the measurement packets are transmitted in complete blocks, rather than interspersed with packets for other vectors. This guarantees accurate jitter measurements in the presence of multiple vectors.

Bandwidth Allocation and Privacy

Another advantageous feature of the network metric system 10 of the present invention is its ability to provide user-definable measurement bandwidth allocation. This allows service providers that do not have a large amount of bandwidth available for measurement traffic to still be able to utilize the network metric system 10 of the present invention. In a preferred embodiment, the vector rates are automatically adjusted in order to utilize only a predetermined amount of bandwidth. Once the user decides upon the amount of bandwidth to be allocated for measurement traffic, each nodal member 30 in the network metric system automatically calculates the rate at which measurement packets are generated based on the number of vectors, packet size, and the bandwidth allocated.

Test bandwidth is the rate at which packets for a vector are transmitted. Transmitted packets are not sent out all at once at the beginning of the measurement period. Instead packets are transmitted out, based on measurement sequence, evenly spaced throughout the measurement period. The maximum test bandwidth depends on certain factors: Maximum bandwidth of the network; the number of vectors at work on the nodal member 30; the number of packets per measurement period per vector; the packet size per vector; the measurement period.

The number of packets transmitted in a measurement period is definable per vector. The minimum number of packets is one. The maximum number of packets transmitted per vector is dependant upon: the test bandwidth; the number of vectors at work on the nodal member 30; the number of packets per measurement period per vector; the packet size per vector; the measurement period.

In this manner, network metric system 10 of the present invention provides accurate network performance measurements on a large scale in commercial, production environments without significantly degrading network performance. Many prior art systems have utilized a “passive” approach to measurements, in which existing network data packets are sampled and examined. One drawback to this passive approach is that if there are no packets traveling in the network, no measurements can occur. Additionally, this passive approach creates security concerns, as individual network packets containing private data are examined. In contrast, the network metric system 10 of the present invention uses an “active” approach that creates proprietary CQOS data packets that are used for measurement purposes. Therefore, the privacy of non-measurement data packets is not compromised since only CQOS data packets are examined.

Packet Size and Payload

Packet size is dependent upon the size of the Ethernet header, Ethernet CRC value, IP header, optional IP header, CQOS header and payload. The Ethernet header, Ethernet CRC value, IP header, and CQOS header are always the same size and this is the minimum size of a measurement packet. The maximum packet size is currently defined as the maximum size of an Ethernet packet. This size is currently equal to 1500 bytes total including the header. This size was chosen in order to try and eliminate further packet fragmentation by routers. This may be changed in the future.

The size of the payload can be changed and is what determines the size of the packet. The minimum size of the payload is 0. The maximum size of the payload is:

Maximum packet size—Ethernet header size—Ethernet CRC value size—IP header size—Optional IP header size—TCP/UCD header size (if used)—CQOS header size

The contents of the payload can be specified as being filled with random numbers, all 0's, or all 1's. The random numbers for each packet are truly randomized and are not generated once for all packets transmitted.

HDEFAULTS

HDEFAULTS are the default values given for vector characteristics. Packet information HDEFAULTS are automatically chosen to populate the packet when configuring a vector. Values of this type include the contents of the CQOS and IP headers. These values also specify the payload contents of the packet.

Control information HDEFAULTS initially set the defaults for information regarding measurement sequence, test bandwidth, and any other information external to the measurement packets themselves. Preferably, users can modify these characteristics, if needed, to other valid values. HDEFAULTS and specific vector characteristics can be retrieved from a nodal member 30. This makes it possible to fill in the HDEFAULT values through an application before setting up a vector on nodal member 30. In a preferred embodiment of the present invention, the HDEFAULTS cannot be changed to other values.

This section contains the HDEFAULT values defined and corresponding definitions in one preferred embodiment of the present invention. It will be appreciated that other defaults may be used in other embodiments of the present invention. Note that an unsigned −1 signifies that all bits in the field are set.

```
          //Payload Contents
          #define CVECTOR_CONFIGURATION_PAYLOAD_HDEFAULT
0×4000000000000000
```

| | |
|---|---|
| #define CVECTOR_CONFIGURATION_PAYLOAD_ALL_ZEROS | 0×01 |
| #define CVECTOR_CONFIGURATION_PAYLOAD_ALL_ONES | 0×02 |
| #define CVECTOR_CONFIGURATION_PAYLOAD_RANDOM | 0×04 |
| //IP Protocol | |

```
          #define CVECTOR_CONFIGURATION_IP_PROTOCOL_HDEFAULT
(uint16)-1
          //IP Protocol Types
          #define CVECTOR_CONFIGURATION_HEADER_TYPE_HDEFAULT
0×4000000000000000
```

| | |
|---|---|
| #define CVECTOR_CONFIGURATION_HEADER_TYPE_NONE | 0×01 |
| #define CVECTOR_CONFIGURATION_HEADER_TYPE_UDP | 0×02 |
| #define CVECTOR_CONFIGURATION_HEADER_TYPE_TCP | 0×04 |
| #define CVECTOR_CONFIGURATION_HEADER_TYPE_RTP | 0×08 |

```
          //TCP Defaults
          #define CVECTOR_CONFIGURATION_TCP_FLAGS_HDEFAULT
          (uint16)-1
          #define CVECTOR_CONFIGURATION_TCP_WINDOW_SIZE_HDEFAULT
(uint32)-1
          #define CVECTOR_CONFIGURATION_TCP_URGENT_POINTER_HDEFAULT
(uint32)-1
          #define CVECTOR_CONFIGURATION_TCP_MSS_HDEFAULT
(uint32)-1
```

| | |
|---|---|
| #define CVECTOR_CONFIGURATION_DEFAULT_GATEWAY_DHCP | 0 |
| //Packet Size | |
| #define CVECTOR_CONFIGURATION_PACKET_SIZE_HDEFAULT | 0 |
| //Burst Size | |
| #define CVECTOR_CONFIGURATION_BURST_SIZE_HDEFAULT | (uint64)-1 |
| //TTL | |
| #define CVECTOR_CONFIGURATION_TTL_HDEFAULT | (ushort)-1 |
| //TOS | |
| #define CVECTOR_CONFIGURATION_TOS_HDEFAULT | (ushort)-1 |
| //Optional IP | |

```
          #define CVECTOR_CONFIGURATION_RECORD_ROUTE_HDEFAULT
(uint8)-1
          #define CVECTOR_CONFIGURATION_SOURCE_ROUTE_TYPE_HDEFAULT
(uint8)-1
          #define CVECTOR_CONFIGURATION_SOURCE_ROUTE_TYPE_NONE
(uint8)0
          #define CVECTOR_CONFIGURATION_SOURCE_ROUTE_TYPE_LOOSE
(uint8)1
          #define CVECTOR_CONFIGURATION_SOURCE_ROUTE_TYPE_STRICT
(uint8)2
          #define CVECTOR_CONFIGURATION_SOURCE_ROUTE_COUNT_HDEFAULT
(uint8)-1
          //Inactivity
          #define CVECTOR_CONFIGURATION_INACTIVITY_TIMEOUT_HDEFAULT
(uint64)-1
          //Outage
          #define CVECTOR_CONFIGURATION_OUTAGE_TRIGGER_HDEFAULT
(uint64)-1
          #define
CVECTOR_CONFIGURATION_OUTAGE_RX_PACKET_COOL_COUNT_HDEFAULT
(uint64)-1
          //ARP
          #define CVECTOR_CONFIGURATION_ARP_RETRY_COUNT_HDEFAULT
(uint16)-1
          #define CVECTOR_CONFIGURATION_ARP_TIMEOUT_HDEFAULT
(uint64)-1
          //Ping
          #define CVECTOR_CONFIGURATION_PING_RETRY_COUNT_HDEFAULT
(uint16)-1
          #define CVECTOR_CONFIGURATION_PING_TIMEOUT_HDEFAULT
(uint64)-1
          #define CVECTOR_CONFIGURATION_PING_PACKET_SIZE_HDEFAULT
(uint16)-1
          //Trace Route
          #define CVECTOR_CONFIGURATION_TRACE_ROUTE_PROBES_HDEFAULT
(uint16)-1
          #define
CVECTOR_CONFIGURATION_TRACE_ROUTE_MAX_TTL_HDEFAULT
(uint16)-1
          #define
CVECTOR_CONFIGURATION_TRACE_ROUTE_WAIT_TIME_HDEFAULT
(uint64)-1
          //General Definitions
          #define
CVECTOR_CONFIGURATION_GONOGO_RETRY_COUNT_HDEFAULT
(uint16)-1
          #define CVECTOR_CONFIGURATION_GONOGO_TIMEOUT_HDEFAULT
(uint64)-1
          //Test Bandwidth
          #define CNODE_CONFIGURATION_TEST_BANDWIDTH_HDEFAULT
(uint64)-1
          //Configuration
```

| | |
|---|---|
| #define CNODE_CONFIGURATION_IP_ADDRESS_DHCP | 0 |
| #define CNODE_CONFIGURATION_IP_ADDRESS_BOOTP | 1 |
| #define CNODE_CONFIGURATION_IP_ADDRESS_RARP | 2 |
| #define CNODE_CONFIGURATION_SUBNET_MASK_DHCP | 0 |
| #define CNODE_CONFIGURATION_DEFAULT_GATEWAY_DHCP | 0 |

```
          #define CNODE_CONFIGURATION_WAIT_TIME_HDEFAULT
(uint64)-1
          #define CNODE_CONFIGURATION_MEASUREMENT_PERIOD_HDEFAULT
(uint64)-1
          //Connectivity
          #define
CNODE_CONFIGURATION_IP_CONNECTIVITY_FREQUENCY_DELAY_HDEFAULT
(uint64)-1
          #define
CNODE_CONFIGURATION_IP_CONNECTIVITY_RETRY_COUNT_HDEFAULT
(uint16)-1
          #define
CNODE_CONFIGURATION_IP_CONNECTIVITY_TIMEOUT_HDEFAULT
(uint64)-1
```

Router Issues

In modern routers there are two paths that can be taken when handling a packet, a slow path and a fast path. The slow path is taken if a packet requires special handling that cannot be handled directly by the hardware. In this case, the processor on the router must be involved to handle the packet. Conversely, the fast path is taken if a packet does not require special handling and does not have to be sent to the processor for handling.

Events that can cause the packet to take the slow path include: TOS field settings that the router needs to modify; a packet size that is too large to be sent out without fragmentation; and a packet with an optional IP header wanting record route or other routing information that must be extracted from the header. A side effect of this route path issue, is that a packet can be retransmitted with greater delay then packets that take the fast path. If this delay is long enough, this can cause packets to be received in the incorrect order, even if the packets are sent to the same router.

The number of routers between the transmitter and receiver, called hops, can have an effect on certain results. As the number of hops increases, the chance of an increase in latency, jitter, and lost packets also increases. Latency and jitter may increase just because of the nature of receiving and retransmission. Lost packets may increase because the packet must go through a greater number of queues where most packets are dropped.

Database

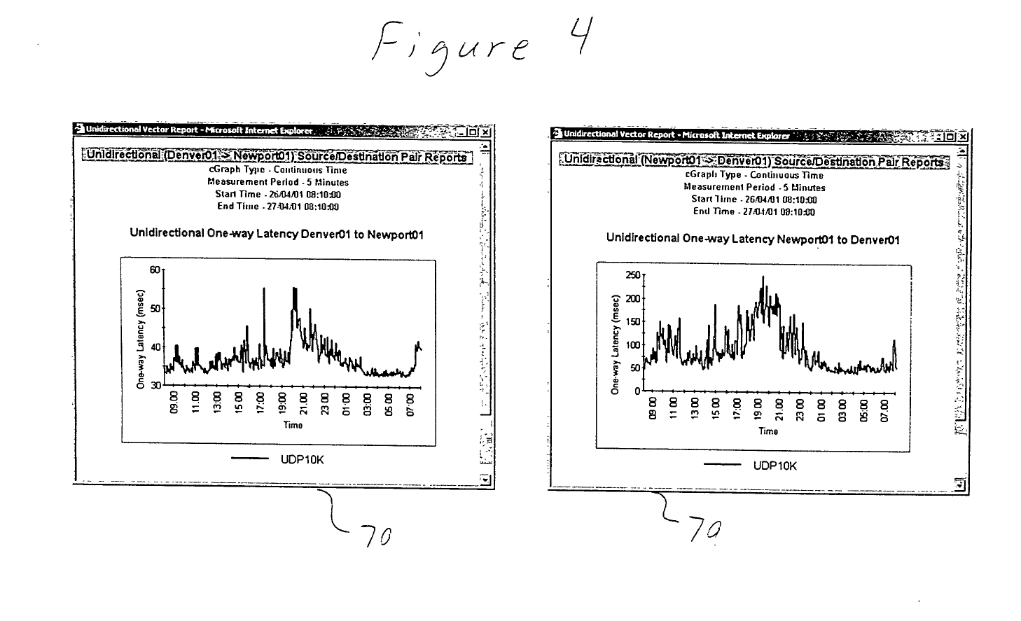

Referring again to FIG. 1 and the database 40 portion of the present invention, the network metric system 10 utilizes a database 40 that is SQL compliant. In a preferred embodiment, the database 40 is an Oracle database that manages vector configuration information and all results. The raw data is stored and available for a variety of reports 70, as shown in FIG. 4. Advantageously, since the reports 70 are not pre-created, but rather are pulled directly from the database 40, based on user-defined parameters, the reports are flexible and reflect true averages for the time periods chosen. The averages can be considered true because they are not averages of averages, as commonly and mistakenly calculated by prior art measurement systems. A preferred database 40 of the present invention stores the original numerator and denominator data so that true averages can be calculated based on the user-defined parameters. The database 40 stores a full range of the complete set of Internet metrics that are described in detail below. Other data fields may also be added to the database 40 in other embodiments as desired. In one preferred embodiment, the network metric system 10 manages all aspects of the database 40. However, in other embodiments, the system 10 also supports unique data access requirements and customized application integration via the database.

In a preferred embodiment of the present invention, the database 40 provides the vector configuration information to the service daemon 60, as well as storing measurement data transmitted from the nodal members 30 via the service daemon 60. The database 40 obtains the vector configuration information from the user interface of the workstation 50 via the application server 46. The application server 46 operatively connect the database 40 and the workstation 50 for system configuration and results display. Results display includes obtaining the results data from database 40 and preparing the data for display.

Workstation

Referring now to the workstation 50 portion of the network metric system 10 of the present invention, a browser based interface is utilized which allows CQOS management and reporting functions to be accessible from a simple web browser. As shown in FIG. 1, in one preferred embodiment the workstation 50 provides a user interfaces with the database 40 through the application server 46 for system configuration. System configuration includes creating and sending vector configuration information to the database 40. In another embodiment of the present invention, the application server 46 is removed, and the workstation 50 interfaces with the service daemon 60. (In this embodiment, the functions of the application server 46 are performed by service daemon 60).

The network metric system 10 provides easy access to reports and management in the system from any computer without requiring special or complicated software installation. Preferably, the work station implements multiple secured access levels. Initial security levels include an administrator level and a user level. Preferably, the administrator has access to system configuration, which includes creation/modification/deletion of nodal members 30, vectors, service types, logical groupings of vectors, and the user access list. These functions are easily accessible to the administrator from the home page of the browser-based user interface. Typically, a user can only view reports. These multiple access levels allow a greater level of security to be implemented into the system. In a preferred embodiment of the network metric system 10, the user interface is secured using the Secure Socket Layer (SSL) protocol and the application server 46 also authenticates user connections.

In a preferred embodiment of the network metric system 10, the workstation utilizes a traffic engineering application as an operations and analysis tool that provides a user interface to the network metric system 10. The primary function of the application is to provide meaningful presentation of network performance measurements in order to allow network planners to view real-time, large-scale, scientific measurement of the Quality of Service performance delivered by their IP networks.

In one preferred embodiment to the present invention, the workstation 50 is utilized to implement user-definable groupings of vectors. Vectors can be logically grouped for ease of vector display and reporting. Useful groupings of vectors may include geographical, customer, network type, or priority based groupings. Additionally, groupings can also overlap (i.e., a vector can be part of several different groups). This configuration allows for ease of use and customizable reporting to suit various reporting needs and users. In some embodiments of the present invention, secure access may be available on a per-group basis.

Alarms

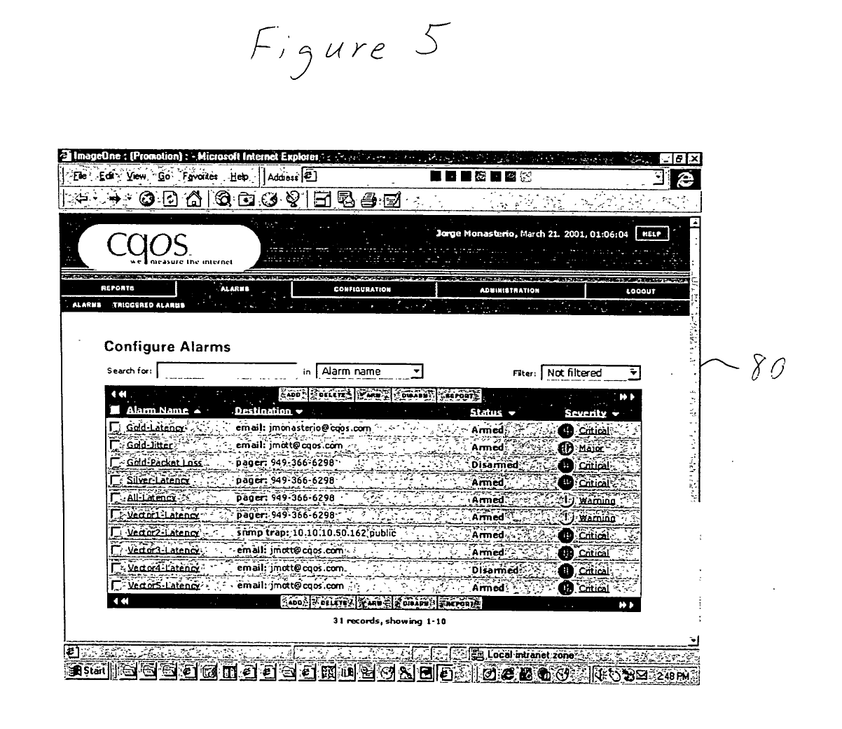

A preferred embodiment of the network metric system 10 provides customised alarms for automatic triggering and notification of emerging performance issues, including integration into Network Management Systems (NMS) to enhance a customer's own network operations facilities. User alerts may be viewed through the user interface 80 (as shown in FIG. 5), and may activate notification functions such as e-mail, paging, or transmission of SNMP traps for integration with established Network Management Systems (NMS) like HP OpenView.

Furthermore, the alarm capability of the network metric system 10 offer a tangible method of dealing with Service Level Agreements (SLA) compliance. Through the use of several levels of alarm severity, set to trigger at thresholds progressively closer to the violation of a SLA, a Service Provider may proactively manage their service level agreements for exactly the conditions that cause non-compliance (e.g., delay or outages).

The alarm capability and general measurement capability of the present invention allows grouping of measurement vectors to give additional SLA benefits. Groups create a method of applying hierarchies to measurement solutions. Through the use of groups, a customer may separate the measurement of their IP network many ways, while only instrumenting the measurement solution once.

Reports

Referring again to FIG. 4, in one preferred embodiment of the network metric system 10 of the present invention, basic real-time reports 70 are automatically generated (without any additional configuration) that show one-way delay, jitter, packet loss and availability measurements. These results are preferably presented in a side-by-side graphical and tabular display, with a separate line for each service type. True averages are provided for each time period, and a minimum, maximum, and standard deviation are also automatically shown. The present invention produces results using numerator and denominator values, so that true averages can be calculated through a sum of all numerators and a sum of all denominators. This avoids the smoothing effect created by calculating an average of averages.

A preferred embodiment in the present invention provides a wide array of reporting options. The system allows a user to designate continuous time or time period history reporting, measurement period, start time, end time, and bi- or unidirectional measurements. This type of flexible reporting with customizable time periods up to and including the current period is highly advantageous to a system user. The network metric system of the present invention preferably provides click through access to powerful results that are not available from prior measurement products or services.

General Algorithm Description

In a preferred embodiment of the network metric system 10, after a vector has been configured on the transmitting nodal member 30, and the receiving nodal member has initialized a vector handler, the receiving nodal member is ready to receive measurement packets. Preferably, a linked list is created for each vector, for each measurement period. Measurement packets received from another nodal member 30 are stored in this linked list in the order received. Packets are stored in an atomic data unit structure. Hereinafter, CQOS measurement packets and atomic data units are considered equivalent. In one preferred embodiment of the present invention, after the measurement period is over, 2 minutes are given for any straggling packets to arrive. When the vector receives the ending measurement period packet, the result calculation routines are called. In one preferred embodiment of the present invention, if the end of measurement period packet is not received within 48 hours, the results are discarded.

In one preferred embodiment of the network metric system 10, the calculation methods take the packets received and fills out the results. The results are then sent to another computer for subsequent analysis. The memory associated with the vector's current measurement period is then freed. The following sections describe elements of the algorithm in more detail.

Identification

In a preferred embodiment of the present invention, as each packet is received, the packet is inserted into the appropriate linked list based on identification information contained in the CQOS header. This identification information is made up of four fields, the sendingnodal memberID, the sendingCVectorID, the measurementPeriodID, and the nodal memberMeasurementPeriodID.

The sendingnodal memberID is a unique identifier that is given to each nodal member 30. The sendingCVectorID is the vector identifier that is unique per sending nodal member 30. The measurementPeriodID is an identifier starting from 0 assigned to each measurement period. The nodal memberMeasurementPeriodID is also an identifier assigned to each measurement period, but if differs from the measurementPeriodID in that it is unique and not 0 based. Based on 3 of the 4 identifiers, that is, sendingnodal memberID, sendingCVectorID, and nodal memberMeasurementPeriodID, a guaranteed unique linked list is located to place the incoming packets into.

Sorting

In a preferred embodiment of the network metric system 10, it is possible that packets received in an order which is different than how they were transmitted. This usually indicates that some packets took different routes than others. This can also happen if certain packets require special handling that causes some packets to take the slow path instead of the fast path on a router. In any case, the packets received must be sorted into their original transmitted order because of jitter calculation requirements. Three special cases need to be dealt with when sorting: duplication, dropped packets, and fragmentation.

Duplicates

Duplicate packets can occur because of various reasons. Duplicate packets are taken into account for most result calculations, except for jitter, outages, and ordering. In these cases, only the first occurrence is used. In order to detect duplicates, the list is traversed and all other items in the list are compared with the current item. If the sequence number of the item and the transmitted timestamp match, then there is a duplicate. The index of the item is placed in an array allocated to store duplicate indexes. The current item is then incremented to the next one until all items in the list have been checked. Note that all items are placed in the duplicate array, even the first occurrence thereof.

Further along in the algorithm, the total number of duplicates, minimum number of duplicates for one item, and maximum number of duplicates for one item are all calculated based on the duplicate array. These are stored in the results as packetsDuplicated, packetsDuplicatedMin, and packetsDuplicatedMax. Eventually, an extra metric may be added that counts duplicates that took a different route from one another using TTL value comparisons.

Dropped Packets

A packet is dropped when a packet is transmitted, but it is not received. The definition of the number of dropped packets is:

(#packets transmitted—#packets received)—#of duplicate packets

The number of packets transmitted is sent along with the special packet at the end of the measurement period. By counting the number of packets in the linked list, the number of packets received is known. When sorting the packets, a list of duplicate packets is built up so that the number of duplicate packets is known. With this information, the formula can be applied and the results saved in the packetsDropped field.

Fragmentation

Fragmentation occurs in routers when a packet arrives that cannot be sent out on the next route without breaking the packet up into smaller pieces. This typically occurs because the next part of the route uses a protocol that has a maximum packet size that is smaller than the size of the current packet. Currently, the maximum size of the packet is set to the maximum size of an Ethernet packet (1500 bytes). To calculate the fragmentation results, a loop is used to retrieve the proper results from all of the atomic packet data.

In accordance with the present invention, packetsFragmented is the sum of all of the packets that were fragmented and packetsFragmentedMin, packetsFragmentedMax, packetsFragmentedAverageNumerator, packetsFragmentedAverageDenominator are the minimum, maximum, and average fragmented packets respectively.

Hop Count (TTL)

Hop count or Time To Live (TTL) is the maximum number of routers that can be traversed when transmitting data. Each time a packet is retransmitted by a router, it's TTL value is reduced by one. A router that receives a packet with a TTL value of 0 drops the packet. The transmitting nodal member 30 saves the original TTL value in the CQOS header so that when the packet arrives the hop count can be calculated. The HDEFAULT value of TTL is the maximum, 255.

To calculate the TTL results, a loop is used to retrieve the proper results from all of the atomic packet data. The current packet's TTL value is temporarily stored so that if the TTL field is different for the next packet, the number of changes can be saved. This indicates that the packet took a different route than the previous packet.

In the present invention, packetsTtlMin, packetsTtlMax, packetsAverageNumerator and packetsAverageDenominator are the minimum, maximum, and average TTL values. packetsTtlChanges is the number of changes of TTL values between all of the packets.

Jitter

Jitter is the difference between the time a packet is expected to arrive, and the time it actually arrives. In other words, a measurement sequence of packets is transmitted one second apart. Jitter is how far apart the packets actually arrived. Jitter is mathematically defined as:

|(Tx−Rx)|=the absolute value of the time transmitted minus the time received.

To measure jitter, a measurement sequence greater than one must be transmitted and received. In addition, the received list of packets must be sorted into transmitted order before calculating jitter. To calculate jitter the packets are traversed in transmitted (sorted) order. For each measurement sequence, the first packet in the measurement sequence is used as a base. The remaining packets in the measurement sequence use the previous packet's received and transmitted timestamps and subtract them from their own to calculate the jitter.

Dropped packets are not counted in jitter calculations. For example, if a burst of 5 packets comes in and packet 3 is dropped, the transmitted sequence of packets that were actually received is: 1,2,4,5. The jitter between packets 1,2 and the jitter between packets 4,5 will be calculated. But since packet 3 was dropped, the jitter between packets 2,3 and 3,4 will not be calculated and included in the results.

The accumulated jitter, minimum jitter, maximum jitter, sum of squares, sum of cubes, jitter count, and jitter burst count are all calculated and saved in jitterStdDevSums, jitterMin, jitterMax, jitterSumSqrd, jitterSumCubed, jitterCount, burstsReceived, respectively.

Latency

Latency is the amount of time that a packet takes to travel from the transmitter to the receiver:

Rx−Tx=Timestamp received−Timestamp transmitted

The timestamp when the packet is transmitted is placed in the packet in the CQOS header upon transmission. When the packet is received another timestamp is recorded.

All the packets are traversed and the average latency, maximum latency, minimum latency, sum, sum of squares, sum of cubes, and number of latencies used for calculation for all packets with non-corrupted CQOS headers are calculated. These values are saved in the latencyAverageNumerator, latencyAverageDenominator, latencyMin, latencyMax, latencyStdDevSums, latencyStdDevSumOfSquares, latencyStdDevSumOfCubes, and latencyStdDevN fields, respectively.

Outages

An outage occurs when a vector is not available. The causes of an outage can vary from a cable not correctly plugged in, to a router or network failure. In terms of measurement, an outage is determined if there are no measurement packets received within a certain time period. This period is set by default to be 10 seconds. However, any defined time period may be used in other embodiments of the present invention. If even 1 measurement packet arrives within this set time period, then no outage will occur. Also, only the first occurrence of a duplicate counts towards a received packet. The remaining duplicates do not reset the outage counter. Therefore, packets with errors in them do not reset the counter. The timestamp of when a packet is received is currently used to calculate outages.

The outage algorithm works by looping through all of the packets received. Starting from the beginning of the received packets, the outage algorithm finds a packet without errors and with no duplicates for it in the list, and saves the received timestamp of the packet. For every packet, except for the first, the outage algorithm subtracts the time of the current valid packet received from the last packet's received timestamp. If the difference is greater than the outage trigger time (currently 10 seconds) then an outage has occurred and is recorded. The algorithm also looks for the last packet received to see if there is an outage of which it can compute the length, without using the maximum of the remainder of the measurement period.

The result of the algorithm is the sum of all outage durations, the minimum outage duration, the maximum outage duration, and the number of outages. These values are saved in the results as: outageDurationTotal, outageDurationMin, outageDurationMax, and outages, respectively.

Ordering

The order in which packets are received (as opposed to how they are is transmitted) is another set of data saved in a preferred embodiment of the present invention. To determine ordering metrics, an algorithm is applied whose purpose is to determine how many items are out of order. The algorithm distinguishes between individual packets and groups of packets. A group of packets is one in which all items in the group are in sequential order with no out of order packets there between. The end result of the algorithm is the number of groups of packets and the number of individual packets out of order. These results are stored in the rxGroupsOutOfOrder and rxPacketsOutOfOrder fields.

In a preferred embodiment of the network metric system 10, enough RAM is used to hold a flag to represent each item in the list for which “presortedness” is to be determine. In one embodiment, this a bit or a byte array, with each having a size or speed advantage, respectively. The algorithm performs the following tasks:

1. Mark any strings at the beginning or end of an array that are already in position.

A) Search array items, that have not been marked as moved, for the minimum and maximum number of items in the array.

B) Examine the first unmarked item in the list (maintain an index to this item) to see if it is the minimum.

If it is the minimum, then compute the length of the string which is already in place in order to simply mark the item as moved without counting the item.

Examine each consecutive item. If this item is item [−1]+1 then move on to the next one. However, if this item is greater than [−1]+1, search the entire array of unmarked items for one which is in between these two items. If found, the end of the string is found, and all these items must be marked as moved without counting them. A value lower than the previous value will also terminate the string. If no value is found in-between, then the sting continues.

C) Perform Step B again, except now moving from the end of the array.

2. Next, in order to move the smallest runs first, start a variable called automark set to 1. This means that as the array is searched for run lengths. If a run is found of length 1, the run is marked immediately as moved, and then counted. This variable is set to the next smallest run length found after searching the array for all runs of automark size. This prevents searching for unused run lengths on the next scan.

3. After every run is moved, the algorithm transforms the new first or last unmarked item in the array from being out of position to being in position. This will only happen if either the run has a min or max value equal to the min or max value of the array, or if the string being moved has been moved from either the beginning or end of the array. If either is the case, then perform either 1(B) or 1(C) above, respectively.

Example 1:

10 11 12 13 45 46 47 14 15 7 1 2 3 4 5 6

Found 7, mark as moved and count. Found 14 15, mark as moved and count. Since 14 and 15 are marked as moved, 10-47 will now be viewed as one long string. Thus, process 1-6 next. Since this string contains the min value, check the first unmarked item in the array now for min (10). Since it is the min, mark as moved without counting. Everything is in order 3 groups of 9 items.

For the following example

MMC=Mark as Moved and Count

MMDC=Mark as Moved and Don't Count

Example 2:

1 3 2 4 6 5 8 7

1 MMDC. 3 MMC. 2 4 MMDC. 6 MMC. 5 MMDC. 8 MMC. 7 MMDC. 3 groups 3 items.

Example 3:

15 40 48 1 12 16 17 18 3 4 5 6 7 8 47

15 MMC. 40 MMC. 48 MMC. 47 MMDC. 1 MMDC. 12-18 MMC. 3-8 MMDC. 4 groups 7 items.

Example 4:

41 42 43 15 40 48 1 12 16 17 18 3 4 5 6 7 8 47

Find 15 MMC. Find 40 MMC. Find 48 MMC. Since 48 max check end string 47 in position MMDC. Find 1 MMC. 41-43 found MMC. Find 12-18 MMC.

Minimal Longest Ascending Subsequence

Another algorithm that is used in a preferred embodiment to address the packet ordering problem is the minimal longest ascending subsequence (MLAS) algorithm. In defining the MLAS algorithm, suppose that there are a set of integers X, with elements x(i), i=1 . . . , N. In a preferred embodiment of the present invention, these integers represent the “send order” of a sequence of packets between nodal members (i.e., the order in which the packets are sent). In theory, the elements x(i) may be any integer, including positive, negative, or zero; and may include any number of repeated elements. However, in a preferred embodiment of the present invention, these integers represent the send order of a sequence of packets and, therefore are positive, non-repeating integers. An example with N=10 is

X:{3, 2, 4, 6, 5, 9, 7, 1, 10, 8}

An ascending subsequence of X, denoted by S of length m, is defined as any subsequence of X which has the properties that (i) it contains m number of elements, (ii) the elements appear in S in the same order as there appear in X, and (iii) the elements of S are in ascending order. In the above example, there are many ascending subsequences in the given sequence. For example, ascending subsequences of length m=3 of possible sequences include:

S₁={2, 4, 6}

S₂={4, 7, 10}

S₃={5, 9, 10}

These are not exhaustive.

For a given X, there exists at least one ascending subsequence of length m=mₘₐₓ. The ascending subsequence(s) of length m=mₘₐₓ, are greater in length than all other ascending subsequences in that given X. For this example mₘₐₓ=5, and

S₁={2, 4, 5, 9, 10}

S₂={2, 4, 5, 7, 10}

S₃={2, 4, 5, 7, 8}

are all ascending subsequences of length m=5. Once again, the above examples are not exhaustive. These subsequences are defined as the longest ascending subsequences of X. Further, the set of longest ascending subsequences can be ranked by comparing their terminal elements, and then, if necessary, the subsequence elements, working backwards. Thus, the longest ascending subsequences S₁, S₂, S₃, are ranked S₃<S₂<S₁ because 8<10 and 7<9. Accordingly, the members belonging to the longest ascending subsequence that has the lowest rank is referred to as the Minimal Longest Ascending Subsequence (MLAS) of the sequence X. For any given X, the MLAS is unique. For X in the above example, the MLAS is S₃.

Thus, in a preferred embodiment of the present invention, for a given sequence of length N (where N=the number of packets in a group of measurement data), the packets that are in the MLAS for the sequence are defined to be “in order.” Accordingly, those packets not belonging to the MLAS are considered to be “out of order.” Using this definition, there are exactly mₘₐₓ packets that are in order, and N−mₘₐₓ packets that are out of order.

Many algorithms for determining the MLAS of a given sequence are known in the art. For example, begin with the proposition that the MLAS for a sequence with elements x(i), where i=1, . . . , K−1, is always known for the first element of the sequence. Here, mₘₐₓ=1, and the MLAS consists simply of x(1). This equation is used together with x(K), to obtain the MLAS for an extended sequence with elements x(i), where i=1, . . . , K. Let tₘ be the index of the terminal element of the minimal ascending subsequence of length m in the sequence x(i), where i=1, . . . , K−1. Then the terminal element of this ascending subsequence is x(tₘ). These terminal elements are ordered, so that x(t₁)<x(t₂) . . . <x(tₘ_{ₘₐₓ}). Now extend x(i), where i=1, . . . , K−1 to x(i), i=1, . . . , K by adding x(K). Next, search the terminals for a j such that x(tⱼ)<x(K)<x(tⱼ₊₁).

If x(K)<x(t₁), then set t₁=K₁, else if x(K)>x(tₘ_{ₘₐₓ}), then increment mₘₐₓ by 1 and add a new ascending subsequence with tₘₐₓ=K, else set tⱼ₊₁=K. Perform this procedure for K=1, . . . , N. Preferably, backpointers are used to keep track of the MLAS. Let bₗ be the index of the predecessor of x(l). Each x(i) either has no predecessor (if it is a minimal ascending subsequence of length l), in which case set bᵢ=−1, or it has just one predecessor. Backpointers are assigned when the algorithm passes through K=i. The output of the algorithm is mₘₐₓ and the arrays are tₘ, where m=1, . . . , mₘₐₓ and bₗ, where l=1, . . . , N. The reconstruction of the MLAS is performed after the basic algorithm has been executed; first starting from x(tₘ_{ₘₐₓ}), and then following the predecessors backwards. It should be emphasized that this step is not necessary if only mₘₐₓ is required. In addition, each minimal ascending subsequence with m=1, . . . , mₘₐₓ can also be found if required by the same procedure, starting from x(tₘ).

Port Counters

Port counters are used to keep track of the number of frames, collisions, and certain types of errors calculated by the ‘layer 2’ (Ethernet layer) interface. Each data packet in the received list contains a running estimate of these items. The estimates in the first packet are subtracted from the estimates in the last received packet and these are stored as results for the measurement period.

The items saved are:

Number of good frames transmitted—estimate_txGoodFrames

Number of transmitted packets with collisions—estimate_txCollisions

Number of transmitted packets with no collisions—estimate_txNoTxCollisitons

Number of good frames received—estimate_rxGoodFrames

There are also various error values that are stored. These are discussed later in the Error Handling/Ethernet Errors sections.

Optional IP Fields

Internet Protocol supports an optional header field that has numerous uses, of which the nodal member 30 currently supports three. Internet Protocol can be used to record the route a packet traversed, or specify loosely or very strictly the way a packet should be routed. The maximum size of this field is specified as 60 bytes. Due to the maximum size limitation, the maximum number of IP addresses that can be recorded or specified is 9.

When recording the route, up to 9 routers (the first 9 routers) the packet traversed are saved in the header. Any other routers visited are not be recorded. In order to record this information, it is necessary for the packet to take the slow path through the router. With a strict route specified, the IP addresses of the routers in the optional field must be traversed exactly as placed in the optional header. Using a loose route, the IP addresses of the routers in the optional field must be traversed, but they can be visited in any order and with additional router visits there between.

The first and last packets that are received are checked for optional IP header information. Whether or not they contain this information, the packet identifiers of the first and last packet are saved in the firstRoutePacketID and lastRoutePacketID fields. The type of optional IP header information is saved in the firstRouteType and lastRouteType fields. The values contained therein are defined as:

CQOS_RESULTS_ROUTE_TYPE_NONE, CQOS_RESULTS_ROUTE_TYPE_RECORD,

CQOS_RESULTS_ROUTE_TYPE_LOOSE,

CQOS_RESULTS_ROUTE_TYPE_STRICT

The actual optional header information and route count for the first and last packet is stored in the firstRouteData, lastRouteData and firstRouteCount, lastRouteCount.

Ethernet Errors

The first set of errors involves errors that were found previously at the Ethernet layer. These ‘layer 2’ errors are summed in each of the appropriate fields in the results for all packets received in the measurement period. These errors are:

The number of CRC errors caused by a bad checksum—rxCRCErrors

Alignment errors—rxAlignmentErrors

Frame too short errors—rxShortFrameErrors

Frame too long errors—rxLongFrameErrors

Total received errors—rxErrors

In addition, the estimates of certain errors in the first packet received are subtracted from the estimates in the last packet received. These are stored as results for the measurement period. These ‘estimate’ values are:

The number of CRC errors caused by a bad checksum—estimate_rxCRCErrors

Alignment errors—estimate_rxAlignmentErrors

Frame too short errors—estimate_rxShortFrameErrors

Resource errors—estimate_rxResourceErrors

CQOS Header Errors

The next set of errors involves the CQOS header checksum. This checksum is a 64 bit value that validates the CQOS header items. If this checksum is incorrect, critical data cannot be retrieved from the packet such that it cannot be used for TTL, IP protocol, TOS, latency, outage, and jitter calculations. The IP payload is also considered corrupted since the CQOS header is part of the IP payload. If the CQOS header is corrupted, the packet is not stored in the array of packets used for further computations and is ignored for the metrics mentioned below. These items are stored in the array of packets used for further calculations:

The received timestamp—rxTimestamp;

The transmitted timestamp—txTimestamp;

The identifier of the current packet in order transmitted—sequence;

The identifier of the burst—cBurstID;

A pointer to the packet—packet; and

A general error value that signifies if there is a layer 2, IP, payload, or CQOS header error-errored.

These items cannot be calculated for the packet if the CQOS header is corrupted:

The identifier of the period—CperiodID (only one packet received in the measurement period has to be free of CQOS header errors to get this anyway);

The number of TTL changes—packetsTtlChanges and all other TTL results;

The number of protocol changes—packetsIPProtocolChanges;

The number of TOS field changes—packetsTosChanges and all other TOS results; and

The latency, jitter, and outages—(depends on rxTimestamp and txTimestamp).

The following results are incremented with each corrupted CQOS header found:

The number of corrupted CQOS headers—packetsCQOSInfoCorrupted; and

The number of payloads corrupted—packetsPayloadCorrupted.

IP Header Errors

The last set of errors involves the IP header checksum. This checksum is a 16 bit value that validates the IP header items. The checksum does not validate the payload that includes the CQOS header. The following items cannot be properly computed or stored if the IP header is corrupted and so the packet is skipped for these calculations:

The number of fragmented packets—packetsFragmented and all other fragmentation results;

The number of TTL changes—packetsTtlChanges and all other TTL results;

The number of protocol changes—packetsIPProtocolChanges; and

The number of TOS field changes—packetsTosChanges and all other TOS results.

The following results are incremented with each corrupted IP header found:

The number of corrupted IP headers—packetsIPCorrupted; and

The number of corrupted optional IP headers—packetsOptionalHeaderCorrupted.

Other Info

Additionally, there are a few other miscellaneous items that are stored in the results.

bytesReceived is the sum of the number of bytes received in total for the measurement period. To calculate the bytesReceived, the packets are traversed and all of the bytes received for each packet are summed.

Up to the first 10 TOS fields are saved into the packetsFirst10Tos array. To find the TOS fields to store, all received packets with valid CQOS and IP headers are traversed. The values in the TOS fields in the CQOS header and IP header are examined. The values are compared and, if they differ, the TOS field setting is saved in the packetsFirst10Tos array. This indicates a router modified the TOS field before re-transmitting the packet. The number of changes stored is placed in packetsFirst10TosCount.

Some general vector information is also stored in the results. The packetsTransmitted, bytesTransmitted, measurementPeriodNanoseconds, and universalTime are retrieved from the vector itself and saved.

Version information is stored in the results. This information consists of:

Transmitting and receiving main versions—txMainVersion, rxMainVersion;

Transmitting and receiving Big Joe versions—txBigjoeVersion, rxBigjoeVersion;

Transmitting and receiving FPGA versions—txFPGAVersion, rxFPGAVersion; and

Transmitting and receiving Mercury versions—txboardVersion, rxboardVersion.

Transmitting and receiving nodal member 30 temperature information is saved in the results. The minimum, maximum, average temperatures of the transmitting and receiving nodal member 30 are saved in:

txtemperatureMin, rxtemperatureMin, txtemperatureMax, rxtemperatureMax, txtemperatureAverageNumerator, rxtemperatureAverageNumerator, txtermperatureAverageDenominator, and rxtemperatureAverageDenominator

Results Structure

The results structure and the elements that comprise the results structure are referenced below, and are used to store all results calculated by the measurement algorithms. In one preferred embodiment of the present invention, reference to the result structure is a reference the structure below.

```
          struct struct_cqosResults {
          //note all counters are in terms of measurement period
          //warn R/S route info
          //reserved info
            uint32 version;
            uint64 sendingnodal memberID;  //ID unique for each nodal
member
            uint64 sendingCVectorID;  //ID of vector unique for each nodal
member
            uint64 measurementPeriodID;  //ID for measurement period (0 based)
            uint64 nodal memberMeasurementPeriodID; //ID for measurement period (unique,
not 0 based)
```

| | |
|---|---|
| uint64 bitMask; | //CQOS_RESULTS_CONFIG0_* |
| uint64 universalTime; | //current UTC time |
| uint64 measurementPeriodNanoseconds; | //length of measurement period in nsec |
| uint64 burstsReceived; | //sum of bursts received |
| uint64 bytesReceived; | //sum of bytes received |
| uint64 bytesTransmitted; | //sum of bytes transmitted |
| uint64 packetsReceived; | //sum of packets received |
| uint64 packetsTransmitted; | //sum of packets transmitted |
| uint64 packetsOutOfOrder; | //# of packets out of order |
| uint64 packetsDuplicatedMin; | //min # of duplicated packets |
| uint64 packetsDuplicatedMax; | //max # of duplicated packets |
| uint64 packetsDuplicated; | //# of packets with duplicates |
| (numerator) | |
| uint64 packetsDuplicatedDenominator; | //# of packets that had 1 or more |
| duplicates (denominator) | |
| uint64 packetsDropped; | //# of packets dropped |
| uint64 packetsFragmented; | //# of packets that were fragmented |
| uint64 packetsFragmentedMin; | //min # of fragmented packets |
| uint64 packetsFragmentedMax; | //max # of fragmented packets |

| | |
|---|---|
| uint64 packetsFragmentedAverageNumerator; | //avg. # of fragmented packets |
| (numerator) | |
| uint64 packetsFragmentedAverageDenominator; | //avg. # of fragmented packets |
| (denominator) | |

| | |
|---|---|
| uint64 packetsIPCorrupted; | //# of packets with corrupted IP header |
| uint64 packetsCQOSInfoCorrupted; | //# of packets with corrupted CQOS |
| header | |
| uint64 packetsPayloadCorrupted; | //# of packets with corrupted payload |
| (includes CQOS header) | |
| uint64 packetsOptionalHeaderCorrupted; | //# of packets with corrupted optional IP |
| header/* WARN SYNC */ | |

uint64 packetsTtlChanges; //# of packets where TTL changed from previous packet

| | |
|---|---|
| uint64 packetsTtlMin; | //min # of TTL |
| uint64 packetsTtlMax; | //max # of TTL |
| uint64 packetsTtlAverageNumerator; | //avg. # of TTL value (numerator) |
| uint64 packetsTtlAverageDenominator; | //avg. # of TTL value (denominator) |
| uint64 packetsIPProtocolErrors; | //# of IP protocol errors |
| uint64 packetsIPProtocolChanges; | //# of packets where IP protocol changed |
| from previous packet | |
| uint64 packetsTosChanges; | //# of packets where TOS field changed |
| from previous packet | |

```
            int  packetsFirst10TosCount;//# of items saved in the packetsFirst10TosCount
field
            int  packetsFirst10Tos[10]; //1st 10 TOS fields that were changed during
transmission
            /* Jitter */
```

| | |
|---|---|
| uint64 jitterMin; | //min jitter # |
| uint64 jitterMax; | //max jitter # |
| uint64 jitterAverageNumerator; | //avg. jitter # (numerator) |
| uint64 jitterAverageDenominator; | //avg. jitter # (denominator) |
| uint64 jitterStdDevSumOfSquares; | //jitter sum of squares |
| uint64 jitterStdDevSumOfCubes; | //jitter sum of cubes |
| uint64 jitterStdDevSums; | //sum of jitter |
| uint64 jitterStdDevN; | //# of jitter calculations |
| /* Latency */ | |
| uint64 latencyTimestampsMismatch; | //# of cases where rx < tx |
| uint64 latencyMin; | //min latency # |
| uint64 latencyMax; | //max latency # |
| uint64 latencyAverageNumerator; | //avg. latency # (numerator) |
| uint64 latencyAverageDenominator; | //avg. latency # (denominator) |
| uint64 latencyStdDevSumOfSquares; | //latency sum of squares |
| uint64 latencyStdDevSumOfCubes; | //latency sum of cubes |
| uint64 latencyStdDevSums; | //sum of latency |
| uint64 latency StdDevN; | //# of latency calculations |
| /* Outages */ | |
| uint64 outages; | //# of outages |
| uint64 outageDurationMin; | //min length of outages in nsec |
| uint64 outageDurationMax; | //max length of outages in nsec |
| uint64 outageDurationTotal; | //total outage length in nsec |
| int firstRouteType; | //IP optional type for first packet |
| int firstRouteCount; | //# of IP addresses in firstRouteData |
| uint64 firstRoutePacketID; | //sequence # of first packet |
| uint32 firstRouteData[9]; | //IP optional IP addresses |
| int lastRouteType; | //IP optional type for last packet |
| int lastRouteCount; | //# of IP addresses in lastRouteData |
| uint64 lastRoutePacketID; | //sequence # of last packet |
| uint32 lastRouteData[9]; | //IP optional IP addresses |
| /* Layer 2 Counters */ | |
| uint64 rxCRC Errors; | //# of checksum errors |
| uint64 rxAlignmentErrors; | //# of alignment errors |
| uint64 rxFrameTooShortErrors; | //# of frame too short errors |
| uint64 rxFrameTooLongErrors; | //# of frame too long errors |
| uint64 rxErrors; | //The above errors plus all others |
| /* Other Info */ | |
| uint32 txSystemType; | //system type of transmitter |
| uchar txMainVersion[8]; | //code version of transmitter |
| uchar txBigjoeVersion[8]; | //Big Joe version of transmitter |
| uchar txFPGAVersion[8]; | //Big Joe FPGA version of transmitter |
| uchar txBoardVersion[8]; | //Big Joe board version of transmitter |
| uint32 rxSystemType; | //system type of reciever |
| uchar rxMainVersion[8]; | //code version of reciever |
| uchar rxBigjoeVersion[8]; | //Big Joe version of reciever |
| uchar rxFPGAVersion[8]; | //Big Joe FPGA version of receiver |
| uchar rxBoardVersion[8]; | //Big Joe board version of receiver |
| uint64 txTemperatureMin; | //min temp of transmitter |
| uint64 txTemperatureMax; | //max temp of transmitter |

```
            uint64 txTemperatureAverageNumerator;  //avg. temp of transmitter (numerator)
            uint64 txTemperatureAverageDenominator;//avg. temp of transmitter
(denominator)
```

| | |
|---|---|
| uint64 rxTemperatureMin; | //min temp of receiver |
| uint64 rxTemperatureMax; | //max temp of receiver |

```
            uint64 rxTemperatureAverageNumerator;  //avg. temp of reciever (numerator)
            uint64 rxTemperatureAverageDenominator; //avg. temp of reciever (denominator)
            /* Port Counters */
```

| | |
|---|---|
| uint64 estimate_txGoodFrames; | //transmitted good frames |
| uint64 estimate_txCollisions; | //transmitted collisions |
| uint64 estimate_txNoTxCollisionErrors; | //transmitted late collision errors + max |
| collision errors (82559:) | |
| uint64 estimate_rxGoodFrames; | //received good frames |
| uint64 estimate_rxCRCErrors; | //received checksum errors |
| uint64 estimate rxAlignmentErrors; | //received alignment errors |
| uint64 estimate_rxResourceErrors; | //received resource errors |
| uint64 estimate_rxShortFrameErrors; | //received short frame errors |
| /* Out of Order Counters */ | |
| uint64 rxPacketsOutOfOrder; | //# of packets out of order |
| uint64 rxGroupsOutOfOrder; | //# of groups out of order |
| }; | |

Atomic Packet Data Structure

In one preferred embodiment of the present invention, this structure is used to store information for each measurement packet received. A linked list of these structures for the current measurement period is located initially by the measurement algorithms. The list is in order received.

struct struct_cqosAtomicPacketData {

| | |
|---|---|
| uint8 cqosheader_IPProtocol; | //original IP protocol |
| uint8 cqosheader_TOS; | //original TOS |
| uint8 cqosheader_TTL; | //original TTL |

| | |
|---|---|
| uint64 cqosheader_nodal memberID; | //ID unique for each nodal |
| member | |

uint64 cqosheader_nodal memberPeriodID;//ID for measurement period (unique,
not 0 based)

| | |
|---|---|
| uint64 cqosheader_CVectorID; | //ID of vector unique for each nodal |
| member | |
| uint64 cqosheader_CPeriodID; | //ID for measurement period (0 based) |
| uint64 cqosheader_BurstID; | //ID for the burst packet is in |
| uint64 cqosheader_PacketID; | //IP of packet (sequence) |
| uint64 cqosheader_TxTimestamp; | //Timestamp when transmitted |

/* Non-CQOS Header derived information */

| | |
|---|---|
| uint32 sourceIPAddress; | //IP address of transmitter |
| ushort bytesReceived; | //Total bytes received −> Includes CRC |
| ushort numberOfFragments; | //Fragments of original packet? |
| uint8 optionalHeaderType; | //UDP/TCP (IP Protocol #) |
| uint8 ipProtocol; | //recieved IP protocol |
| uint8 ttl; | //received TTL |
| uint8 tos; | //received TOS |
| uint64 rxTimestamp; | //received timestamp |

uint8 xxRoute; //IP optional route info,0 no rr/sr/lr. Else 0×7=rr, 0×83=lr,
0×89=sr

| | |
|---|---|
| uint8 recordRouteCount; | //number of routes recorded if option |
| used | |
| uint32 recordRouteInformation[9]; | //route info if option used |
| /* Port Counters */ | |
| uint64 estimate_txGoodFrames; | //# of transmitted good frames |
| uint64 estimate_txCollisions; | //# of transmitted collisions |

uint64 estimate_txNoTxCollisionErrors; //# of transmitted late collision errors +
max collision errors

| | |
|---|---|
| uint64 estimate_rxGoodFrames; | //# of received good frames |
| uint64 estimate_rxCRCErrors; | //# of received CRC errors |
| uint64 estimate_rxAlignErrors; | //# of received alignment errors |
| uint64 estimate_rxResourceErrors; | //# of received resource errors |
| uint64 estimate_rxShortFrameErrors; | //# of received short frame errors |
| /* Packet Error Counters */ | |
| uint32 12_rxCRCError:1; | //packet has level 2 checksum error |
| uint32 12_rxAlignmentError:1; | //packet has level 2 alignment error |
| uint32 12_rxFrameTooShortError:1; | //packet has level 2 frame too short error |
| uint32 12_rxFrameTooLongError:1; | //packet has level 2 frame too long error |
| uint32 12_rxError:1; | //packet has level 2 error |

```
            uint32 cqosheader_PayloadChecksumOk:1; //packet payload checksum ok
          uint32 cqosheader_HeaderChecksumOk:1; //packet CQOS header checksum ok
```

| | |
|---|---|
| uint32 ipHeaderChecksumOk:1; | //packet IP header checksum ok |
| uint32 ipHeaderMiscError:1; | //packet IP misc error |
| uint32 ipProtocolError:1; | //packet IP protocol error |
| uint32 optionalHeaderChecksumOk:1; | //packet IP optional header error |
| uint32 errored:1; | //packet general error |
| /* House Keeping Information */ | |
| pATOMICPacketData next; | //pointer to next packet |
| }; | |

Calculation Packet Data Structure

An array of these structures is computed from the original list of AtomicPacketData structures by the measurement algorithms. This list is used to eliminate packets with any CQOS header errors and make it easier to reference the packets without traversing the list each time.

struct struct_recordInfo {

| | | |
|---|---|---|
| uint64 | rxTimestamp; | //timestamp recieved |
| uint64 | txTimestamp; | //timestamp transmitted |
| uint64 | sequence; | //sequence number (ID) of the packet |
| uint64 | cBurstID; | //burst ID number |
| int | errored; | //error flag |
| int | duplicatedCounted; | //duplicate already counted flag |

| | |
|---|---|
| pATOMICPacketData packet; | //pointer to ATOMICPacketData item |
| }; | |

System Operation

The logical operations of a preferred embodiment network metric system 10 of the present invention utilize the components of the system in a logical sequence. In a preferred embodiment of the network metric system 10 of the present invention, a vector is the fundamental measurement unit. A vector is defined as a packet type and source and destination pair. The packet type describes what the characteristics of the packet are. All packets for the vector have the same characteristics (i.e. packet types.) Packet types include the ability to control: length of packet; payload type (all zero's, all one's or random); header type (udp, TCP, none); udp/tcp source and destination port numbers; TTL value; TOS/DiffServ bits; IP protocol value; IP loose, strict, and record route options; Default gateway to use for routed networks; Source and Destination addresses; and TCP Header information such as [window size, MSS option, FLAGS, urgent pointer].

The format of the packet is as follows:

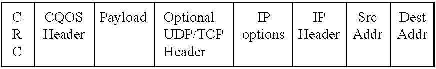

A vector is created by the service daemon 60. The service daemon 60 reads the configuration parameters of the vector from a database and communicates with the nodal member 30 via CQOS Protocol to create the vector on the sending nodal member 30. If the nodal member 30 accepts the configuration request, the nodal member responds to the service daemon 60 with an “ok” status. If the nodal member 30 does not accept the configuration request, the nodal member will not create the vector and responds with an error status. Once the vector is created on the sending nodal member 30, the service daemon 60 issues the Readiness test command (via CQOS Protocol). The readiness test includes a set of tests including the Go/NoGo test, as previously discussed.

Once again, the tests included are:

(1) ARP Default Gateway: Send an ARP (Address Resolution Protocol) request to the gateway and store into memory round-trip time (RTT) of the ARP request, execute time, the IP address of the default router, and the MAC address (if valid response) of the default address;

(2) Ping Default Gateway: Ping (ICMP Echo Message) to the gateway and store into memory the RTT time, execute time, and IP Address of the gateway;

(3) Ping Receiving nodal member: Ping the receiving (destination) nodal member 30 and record the RTT time, execute time and IP address of the receiving nodal member 30;

(4) Trace Route to Receiving nodal member: Trace Route to the receiving nodal member 30 and record each hops IP address, RTT. Also record the execute time and destination IP address; and

(5) Go/NoGo to Receiving nodal member: A message with the parameters of the vector, user ID, and password are sent to the receiving nodal member 30 asking for permission to make measurements. The receiving nodal member 30 looks at the parameters and compares the user ID and password with an Access Control List (ACL) maintained within the receiving nodal member 30. If the parameters are ok, and the user ID and password matches with a valid ACL entry, then the receiving nodal member 30 responds with a GO confirmation. Once the GO confirmation is received by the sending nodal member 30, then measurements start on the next measurement period (5 minute boundary). If the receiving nodal member 30 does not accept the parameters or user ID/password combination, then either NO response is be given to the sending nodal member 30, or a NoGo message is sent. In either negative case, the sending nodal member 30 will not under any circumstances send measurement packets. The feature is for security in that the users can not create vectors to systems other than nodal members 30 nor create vectors to nodal members 30 that they do not control.

Once the GO confirmation is received by the sending nodal member 30, then measurement packets are sent, which are formed as shown above. The number of packets sent is based on the number of total vectors within the sending nodal member 30, the characteristics of those vectors (e.g. packet size, packets/sequence) and the measurement bandwidth allocated to the sending nodal member 30. Packets are sent at the measurement bandwidth rate over the measurement period (5 minutes). Every measurement period, the number of packets sent is recalculated before the measurements packets sent. Measurement packets are sent until the vector is stopped or deleted.

As the receiving nodal member 30 receives measurement packets, the nodal member pre-processes them into a unit of data referred to as an Atomic Packet. The Atomic Packet stores information such as the packet ID, Vector ID, sending nodal member ID, transmit timestamp, receive timestamp, original TTL value and received TTL value, as well as the status of the various regions such as the IP header, UDP/TCP/Other header, payload and CQOS header.

Once the measurement period is over, which is indicated by a message from the sending nodal member 30, the receiving nodal member 30 processes the Atomic Packets via its algorithms (as described above). Once completed, this information is stored for up to 36+ hours. The information is then sent to the service daemon 60 via the CQOS Protocol. If the service daemon 60 does not receive the result packet until some time later than expected, or if the service daemon receives a subsequent results packet, the service daemon polls the nodal member 30 for the results. The service daemon 60 can poll the nodal member 30 for data that was computed/measured 36+ hours in the past.

By computing Atomic Packets and then reducing that information down to a small amount of information (the core metrics), the Internet metric system 10 allows for a very scalable system that is highly distributed. In addition, since the results data is constant in size regardless of the number of measurement packets sent, the system is far more efficient at storing data and reporting data.

Although the invention has been described in language specific to computer structural features, methodological acts, and by computer readable media, it is to be understood that the invention defined in the appended claims is not necessarily limited to the specific structures, acts, or media described. Therefore, the specific structural features, acts and mediums are disclosed as exemplary embodiments implementing the claimed invention.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A system for performing measurements over a network, the system comprising:
nodal members forming a nodal network between which one-way measurements are performed over asymmetrical paths, wherein the measurements are performed at the Internet Protocol layer, wherein the number of nodal members in the nodal network is scaleable; and
wherein the measurements include packet ordering data for received packets that is defined using a minimal longest ascending subsequence algorithm.

2. The system of claim 1, wherein the packets that are in the minimal longest ascending subsequence are considered in order.

3. The system of claim 1, wherein the packets that are not in the minimal longest ascending subsequence are considered out of order.

4. The system of claim 1, wherein the nodal members are used as measurement points and have synchronized timing systems.

5. The system of claim 4, wherein the nodal members support Network Time Protocol synchronization and Global Positioning System synchronization.

6. The system of claim 1, wherein the one-way measurements performed by nodal members at the Internet Protocol layer provide cross application and cross platform comparable measurements.

7. The system of claim 1, wherein the system utilizes a vector based measurement system to achieve service-based, comparable measurements.

8. The system of claim 7, wherein the vector based measurement system defines a vector by an IP source, an IP destination, and service type.

9. The system of claim 1, wherein the nodal members perform processing of measurement data.

10. The system of claim 1, wherein the nodal members implement a processing algorithm on raw measurement data recorded for each measurement period, and wherein the processing algorithm compacts the raw measurement data.

11. The system of claim 1, wherein the nodal members include multiple on-board processors, enabling one processor to handle management processes and another processor to handle measurement processes.

12. The system of claim 1, wherein the nodal members are functional without requiring a transmission control protocol session with a service daemon.

13. A method for performing measurements over a network, the method comprising:
performing one-way measurements between nodal members over asymmetrical paths, wherein the measurements are performed at the Internet Protocol layer in a scalable environment;
processing data produced from the one-way measurements between nodal members;
transmitting the processed measurement data from the nodal members to a database; and
analyzing the processed measurement data, wherein the measurements include packet ordering data for received packets that is defined using a minimal longest ascending subsequence algorithm.

14. The system of claim 13, wherein the packets that are in the minimal longest ascending subsequence are considered in order.

15. The system of claim 13, wherein the packets that are not in the minimal longest ascending subsequence are considered out of order.

16. The method of claim 13, wherein the performing of one-way measurements between nodal members is achieved by transmitting measurement packets with CQOS headers between nodal members.

17. The method of claim 13, wherein the processing of the measurement data produced from the one-way measurements between nodal members compacts the measurement data.

18. The method of claim 13, wherein the nodal members perform the processing of measurement data.

19. The method of claim 13, wherein the nodal members implement a processing algorithm on raw measurement data recorded for each measurement period, and wherein the processing algorithm compacts the raw measurement data.

20. The method of claim 13, wherein the nodal members are used as measurement points and have synchronized timing systems.

21. The method of claim 20, wherein the nodal members support Network Time Protocol synchronization and Global Positioning System synchronization.

22. The method of claim 13, wherein the nodal members include multiple on-board processors, enabling one processor to handle management processes and another processor to handle measurement processes.

23. The method of claim 13, wherein the nodal members are functional without requiring a TCP session with the service daemon.

24. A system for performing measurements over a network, the system comprising:
a nodal network that includes multiple nodal members between which one-way measurements are performed over asymmetrical paths, wherein the measurements are performed at the Internet Protocol layer, wherein the number of nodal members used as measurement points in the nodal network is scaleable, and wherein the measurements include packet ordering data for received packets that is defined using a minimal longest ascending subsequence algorithm;
a database, wherein the database stores measurement data recorded by the nodal members;
a workstation operatively associated with the database, wherein the workstation facilitates system configuration and reporting of measurement data; and
at least one service daemon, and wherein the service daemon interfaces with the nodal network and the database, instructs the nodal members to create vectors, obtains vector configuration information from the database, and processes results data transmitted from the nodal members to the database.

25. The system of claim 24, wherein the packets that are in the minimal longest ascending subsequence are considered in order.

26. The system of claim 24, wherein the packets that are not in the minimal longest ascending subsequence are considered out of order.

27. The system of claim 24, further comprising an application server that interfaces between the workstation and the database for system configuration and results display.

28. The system of claim 24, wherein the workstation includes a user interface that is alterable without modifying underlying system architecture.

29. The system of claim 24, wherein the workstation utilizes a browser based interface to provide system reports and management functions to a user from any computer connected to the Internet without requiring specific hardware or software.

30. The system of claim 24, wherein the system implements an access protocol that is selectively configurable to allow third party applications to access the system.

31. The system of claim 24, wherein CQOS protocol is a non-processor intensive, non-bandwidth intensive protocol for transmitting processed, compacted measurement data.

32. The system of claim 24, wherein measurement data from each measurement period is sent from the nodal members to the database via CQOS protocol.

33. The system of claim 24, wherein the nodal members communicate with each other using CQOS protocol.

34. The system of claim 24, wherein the database is SQL compliant, and stores vector configuration information and results measurement data to allow generation of true averages in response to user defined parameters.

35. The system of claim 24, wherein the system utilizes a vector based measurement system to achieve service-based, comparable measurements.

36. The system of claim 24, wherein the system utilizes a vector based measurement system that defines a vector by an IP source, an IP destination, and service type.

37. The system of claim 24, wherein the nodal members implement hardware time stamping.

38. The system of claim 37, wherein each nodal member includes an output buffer, and wherein during the hardware time stamping process, header information and data information fill the output buffer before a time stamp is applied to the output buffer.

39. The system of claim 24, wherein nodal members in the nodal network are capable of user-defined, customizable groupings for area-specific measurement reporting.

40. The system of claim 24, wherein the system utilizes a measurement packet having a format that includes Ethernet header, IP header, optional IP routing options, UDP/TCP header, payload, and CQOS header.

41. The system of claim 40, wherein checksums are calculated on the measurement packets for payload, IP header, UDP/TCP header, and CQOS header.

42. The system of claim 24, wherein the system facilitates user-definable bandwidth allocation for measurement traffic.

43. The system of claim 24, wherein each nodal member automatically calculates a rate at which measurement packets are generated, such rate based upon the number of vectors, packet size, and bandwidth allocation.

44. The system of claim 24, wherein the system performs highly accurate measurements at a high sampling rate.

45. A method for performing measurements over a network, the method comprising:
performing one-way measurements between nodal members over asymmetrical paths, wherein the measurements are performed at the Internet Protocol layer in a scalable environment, and wherein the measurements include packet ordering data for received packets that is defined using a minimal longest ascending subsequence algorithm;
processing data in the nodal members produced by the one-way measurements between nodal members;
transmitting the processed measurement data from the nodal members to a database via at least one service daemon that interfaces with the nodal network and the database, wherein the at least one service daemon instructs the nodal members to create vectors, obtains vector configuration information from the database, and processes results data transmitted from the nodal members to the database; and
providing for system management capabilities and measurement data analysis via the workstation.

46. The system of claim 45, wherein the packets that are in the minimal longest ascending subsequence are considered in order.

47. The system of claim 45, wherein the packets that are not in the minimal longest ascending subsequence are considered out of order.

48. The method of claim 45, further comprising an application server that interfaces between the workstation and the database for system configuration and results display.

49. The method of claim 45, wherein the service daemon performs automatic error recovery to retrieve missing measurement data when measurement data is lost in transmission.

50. The method of claim 45, wherein the workstation includes a user interface that is alterable without modifying underlying system architecture.

51. The method of claim 45, wherein the workstation utilizes a browser based interface to provide system reports and management functions to a user from any computer connected to the Internet without requiring specific hardware or software.

52. The method of claim 45, wherein the system implements an access protocol that is selectively configurable to allow third party applications to access the system.

53. The method of claim 45, wherein CQOS protocol is a non-processor intensive, non-bandwidth intensive protocol for transmitting processed, compacted measurement data.

54. The method of claim 45, wherein measurement data from each measurement period is sent from the nodal members to the database via CQOS protocol.

55. The method of claim 45, wherein the nodal members communicate with each other using cQOS protocol.

56. The method of claim 45, wherein the database is SQL compliant, and stores vector configuration information and results measurement data to allow generation of true averages in response to user defined parameters.

57. The method of claim 45, wherein the system utilizes a vector based measurement system to achieve service-based, comparable measurements.

58. The method of claim 57, wherein the vector based measurement system defines a vector by an IP source, an IP destination, and service type.

59. The method of claim 57, wherein vectors in the vector based measurement system are capable of disablement without deletion from the database.

60. The method of claim 45, wherein the nodal members implement hardware time stamping.

61. The method of claim 60, wherein each nodal member includes an output buffer, and wherein during the hardware time stamping process, header information and data information fill the output buffer before a time stamp is applied to the output buffer.

62. The method of claim 45, wherein nodal members in the nodal network are capable of user-defined, customizable groupings for area-specific measurement reporting.

63. The method of claim 45, wherein the system utilizes a measurement packet having a format that includes Ethernet header, IP header, optional IP routing options, UDP/TCP header, payload, and CQOS header.

64. The method of claim 63, wherein checksums are calculated on the measurement packets for payload, IP header, UDP/TCP header, and CQOS header.

65. The method of claim 45, wherein the system facilitates user-definable bandwidth allocation for measurement traffic.

66. The method of claim 45, wherein each nodal member automatically calculates a rate at which measurement packets are generated, such rate based upon the number of vectors, packet size, and bandwidth allocation.

67. A system for performing network measurements utilizing a readiness test, the system comprising:
a nodal network that includes multiple nodal members between which one-way measurements are performed at the Internet Protocol layer;
a measurement database;
a workstation, wherein the workstation provides a user interface for system configuration and reporting of measurement data;
an application server, wherein the application server interfaces between the database and the workstation for system configuration and results display; and
a service daemon, wherein the service daemon interfaces the nodal network and the database;
wherein a transmitting nodal member performs a readiness test to ensure the willingness of a receiving nodal member to accept measurement traffic before the transmitting nodal member begins to transmit measurement traffic to the receiving nodal member; and
wherein the measurements include packet ordering data for received packets that is defined using a minimal longest ascending subsequence algorithm.

68. The system of claim 67, wherein the packets that are in the minimal longest ascending subsequence are considered in order.

69. The system of claim 67, wherein the packets that are not in the minimal longest ascending subsequence are considered out of order.

70. The system of claim 67, wherein the readiness test comprises:
broadcasting an Address Resolution Protocol request to a gateway/local host in order to obtain its physical hardware address;
pinging the gateway/local host;
pinging the receiving nodal member;
performing a traceroute to the receiving nodal member; and
performing a Go/No Go test using a CQOS protocol, wherein the CQOS protocol is a non-processor intensive, non-bandwidth intensive protocol for nodal members to communicate with each other.

71. The system of claim 70, wherein the Go/No Go test is performed by a transmitting nodal member requesting and obtaining permission from a receiving device to transmit measurement traffic before the transmitting nodal member transmits the measurement traffic,
thereby ensuring protection against unwanted measurements being made on nodal members and against measurement traffic being sent to a non-nodal member receiving device.

72. The system of claim 67, wherein the readiness test verifies linkage and reachability of nodal members before measurements are performed without creating unnecessary duplication of effort in the network.
